(19) United States
(12) Patent Application Publication
(10) Pub. No.: US 2026/0252282 A1
(43) Pub. Date: Aug. 27, 2026

(54) STORAGE MEDIUM, INFORMATION PROCESSING APPARATUS, AND INFORMATION PROCESSING METHOD

(71) Applicant: CANON KABUSHIKI KAISHA, Tokyo (JP)

(72) Inventor: KOJI NIWA, Kanagawa (JP)

(21) Appl. No.: 19/546,894

(22) Filed: Feb. 23, 2026

(30) Foreign Application Priority Data
Feb. 27, 2025 (JP) 2025-030141

(51) Int. Cl. G06F 3/12

(52) U.S. Cl. CPC G06F 3/1205; G06F 3/1256

(57) ABSTRACT

A non-transitory computer-readable storage medium stores a program for causing a computer to execute a method including displaying a first object configured to configure a print setting for a first file, the first object including an input field, wherein in a case where a natural language indicating an instruction to print a second file different from the first file is input into the input field, a second object configured to configure a print setting for the second file is displayed in a state where the first object is displayed.

### BACKGROUND

### Field of the Technology

The present disclosure relates to a storage medium, an information processing apparatus, and an information processing method.

### Description of the Related Art

Japanese Patent Application Laid-Open No. 2020-52507 describes a technology that enables a user to configure print settings or issue a print instruction via natural language conversation with a chatbot.

The user may wish to configure print settings in detail for file printing using natural language. When configuring print settings using the technology described in Japanese Patent Application Laid-Open No. 2020-52507, the user can designate a setting of each setting item by exchanging chats with the chatbot for each setting item, thereby configuring print settings. Similarly, the user can configure print settings using artificial intelligence (AI) in natural language.

### SUMMARY

An object (card) may be displayed on a chat screen to confirm or change settings in a case where a natural language indicating an instruction to print a file is input by a user. The object may include a dedicated text input field. The text input field is configured to receive a natural language indicating an instruction to change or add a setting. However, a natural language indicating an instruction to print a different file may be input. In that case, if the displayed object is updated, the updated object is no longer the object for the original file, which causes an issue that it becomes difficult to issue an instruction to print the original file.

Embodiments of the present disclosure are directed to facilitating the designation of a printing target file specified by a user using natural language.

According to embodiments of the present disclosure, a non-transitory computer-readable storage medium stores a program for causing a computer to execute a method including displaying a first object configured to configure a print setting for a first file, the first object including an input field, wherein in a case where a natural language indicating an instruction to print a second file different from the first file is input into the input field, a second object configured to configure a print setting for the second file is displayed in a state where the first object is displayed.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a network configuration according to the present disclosure.

FIG. 2A is a diagram illustrating a hardware configuration of a client personal computer (client PC).

FIG. 2B is a diagram illustrating a hardware configuration of a plug-in server.

FIG. 3A is a diagram illustrating a software configuration of an application.

FIG. 3B is a diagram illustrating a software configuration of an artificial intelligence (AI) assistant.

FIG. 3C is a diagram illustrating a software configuration of a plug-in.

FIG. 3D illustrates an example of a plug-in manifest.

FIG. 3E is a diagram illustrating a software configuration of a plug-in server.

FIG. 4A illustrates an example of a card post posted by the plug-in according to the present disclosure (in which a prompt is displayed directly).

FIG. 4B illustrates an example of a card post posted by the plug-in according to the present disclosure (in which a parameter is displayed).

FIG. 4C illustrates an example of a card post posted by the plug-in according to the present disclosure (in which an abstract file designation is input).

FIG. 4D illustrates an example of a card post posted by the plug-in according to the present disclosure (in which a file is attached).

FIG. 5A illustrates an example of a card update updated by the plug-in according to the present disclosure (print setting change, before updating).

FIG. 5B illustrates an example of a card update updated by the plug-in according to the present disclosure (print setting change, after updating).

FIG. 5C illustrates an example of a card update updated by the plug-in according to the present disclosure (file change, before updating).

FIG. 5D illustrates an example of a new card post posted by the plug-in according to the present disclosure (file change).

FIG. 5E illustrates an example of a card update updated by the plug-in according to the present disclosure (new card generation setting).

FIG. 5F illustrates an example of a new card post posted by the plug-in according to the present disclosure (new card generation setting).

FIG. 5G illustrates an example of a card update posted by the plug-in according to the present disclosure (print execution, after updating).

FIG. 5H illustrates an example of a card update posted by the plug-in according to the present disclosure (print execution, after print execution).

FIG. 5I illustrates an example of a card update posted by the plug-in according to the present disclosure (print execution, after file designation).

FIG. 5J illustrates an example of a card update posted by the plug-in according to the present disclosure (error card).

FIG. 6A illustrates a plug-in invoking sequence of the AI assistant.

FIG. 6B illustrates an example of a card creation sequence of a plug-in execution control unit.

FIG. 6C illustrates a plug-in invoking sequence performed when a card is updated or a new card is created.

FIGS. 7A and 7B illustrate an example of an instruction statement for print setting generation.

FIG. 8 illustrates an example of a card template according to the present disclosure.

FIG. 9 illustrates a card updating sequence according to a second embodiment.

FIG. 10A illustrates an example of a card update according to the second embodiment (print setting change, before updating).

FIG. 10B illustrates an example of a card update according to the second embodiment (print setting change, after updating).

FIG. 10C illustrates an example of a card update according to the second embodiment (after link selection).

### DESCRIPTION OF THE EMBODIMENTS

Embodiments of the present disclosure will be described below with reference to the drawings. It should be noted that the embodiments described below are not intended to limit the scope of the disclosure and that not all of the combinations of features described in the embodiments are necessarily essential to the solution of the disclosure.

It should be noted that according to the present embodiment, generative artificial intelligence (generative AI) refers to a technology that automatically generates various types of content that are normally created by a human, such as text, image, music, or video. Further, the generative AI generates these items based on knowledge acquired through deep learning, rather than performing processing according to a predetermined rule as in conventional AI.

Further, according to the present embodiment, an artificial intelligence (AI) assistant refers to, for example, an AI assistant configured to receive natural language input via a chat field (input field) of an application and display a response to the input generated using generative AI in the chat field of the application.

Further, according to the present embodiment, the natural language input may also be referred to as a prompt 3100. A specification of the prompt 3100 is not particularly limited and conforms to a specification of each AI assistant. For example, a user may attach an image file or a document file.

It should be noted that according to the present embodiment, the natural language format refers to a format corresponding to ordinary human conversation, such as “Tell me the weather in Tokyo tomorrow”. The natural language format is advantageous in that it facilitates easier operation because it is unnecessary to provide word-separate input as in a web search, such as “Tokyo weather tomorrow”.

Further, according to the present embodiment, a card is a form of a post (display) and refers to a card that includes information such as text or image and an object via which the user issues an additional operation instruction after verifying content, and the displayed content is updated based on a user operation. For example, the information and the object are displayed within the same area.

Further, according to the present embodiment, LLM is short for Large Language Model.

### First Embodiment

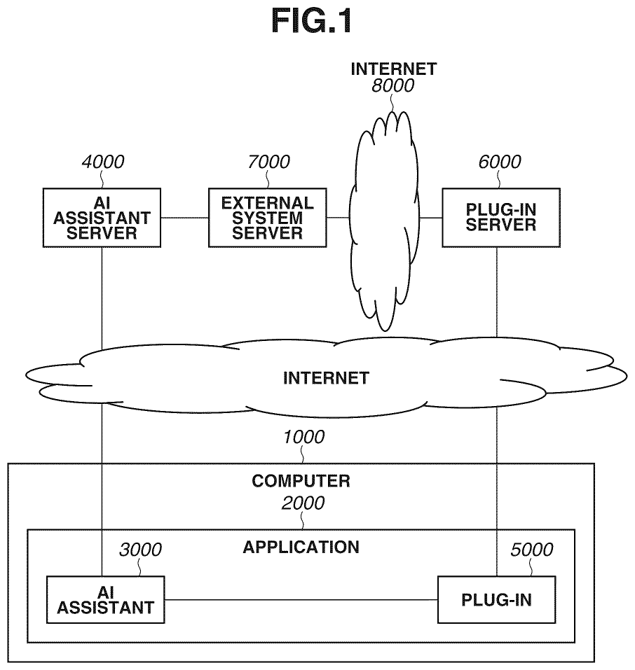

FIG. 1 illustrates an example of a configuration of a system according to the present embodiment. A network configuration diagram according to the present embodiment includes a computer 1000, which is a terminal apparatus, an artificial intelligence (AI) assistant server 4000, a plug-in server 6000, and an external system server 7000. These components are connected via the Internet 8000 and can communicate with each other.

Further, the computer 1000 includes an application 2000, and the application 2000 includes an AI assistant 3000 and a plug-in 5000.

For example, the computer 1000 is placed in an office and connected to the external Internet 8000 via an intranet (not illustrated) and a router (not illustrated) so that the computer 100 can communicate with Internet 8000. The computer 1000, the AI assistant server 4000, the plug-in server 6000, and the external system server 7000 herein are examples of an information processing apparatus. Further, the computer 1000 is also an example of a user terminal.

The application 2000 runs on the computer 1000, and the AI assistant 3000 is installed in application 2000. Furthermore, adding the plug-in 5000 to the application 2000 expands the function of the application 2000.

In the present disclosure, the plug-in 5000 refers to a plug-in configured to provide a function that communicates with the plug-in server 6000 and executes a predetermined process, and mainly refers to a plug-in that uses generative AI during its processing flow. However, the use of generative AI during the processing flow is not strictly required. Further, the plug-in 5000 can be invoked by a user operating the application 2000 or by the AI assistant 3000. Furthermore, the plug-in 5000 can provide information acquired via the plug-in server 6000 as an additional information source for the AI assistant server 4000 to generate a response.

The AI assistant server 4000 includes a function that generates a response to the prompt 3100 input to the AI assistant 3000 on the application 2000 using a generative AI model specialized in natural language processing, such as an LLM.

The plug-in server 6000 includes a function that performs a predetermined operation on the external system server 7000 based on details of communication with the application 2000. Furthermore, the plug-in server 6000 includes a function that generates content using a predetermined generative AI based on the content of the prompt 3100, and a function that causes the AI assistant 3000 to post information at least including the content generated by the generative AI as a card 3200.

It should be noted that according to the present embodiment, the card 3200 is an example of an object and displays a variety of information using an object, such as a display field, an input field, or a button. Furthermore, the user can select a button displayed on the card 3200, thereby issuing an instruction to execute a process corresponding to the selected button.

The external system server 7000 is connected to the plug-in server 6000 so that the external system server 7000 can communicate with the plug-in server 6000 via the Internet 8000, and includes a function that receives an operation from the plug-in server 6000.

It should be noted that the application 2000 may be a client application that exists on the computer 1000, or a web application that can be connected via the Internet 8000. Further, the plug-in 5000 may be deployed on the computer 1000, the web application, or the AI assistant server 4000.

Further, a function enabling the computer 1000 to communicate with the AI assistant server 4000 and the plug-in server 6000 may be installed in the application 2000 or included in the AI assistant 3000 and the plug-in 5000. It should be noted that the AI assistant 3000 and the plug-in 5000 are invoked by the application 2000.

### Hardware Configuration

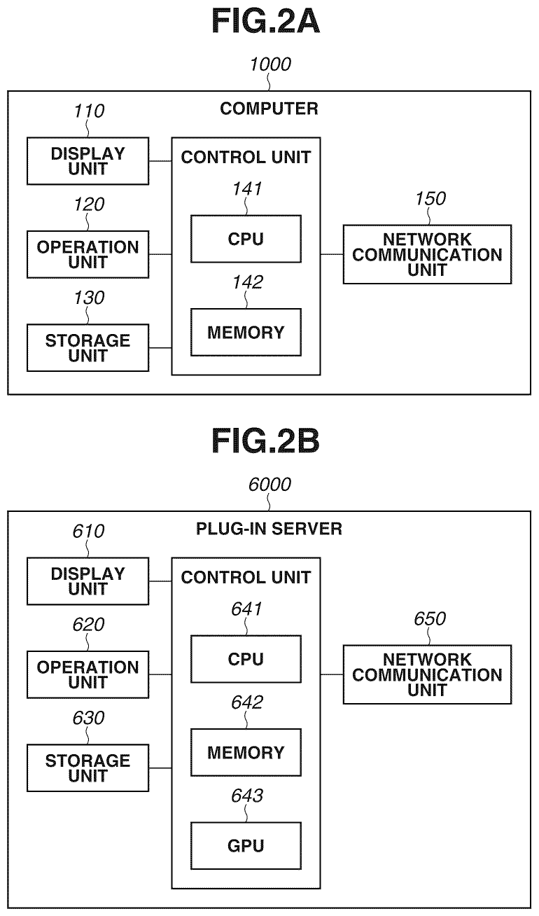

An example of a hardware configuration of each apparatus of the system according to the present embodiment will be described with reference to FIGS. 2A and 2B.

FIG. 2A illustrates an example of a hardware configuration of the computer 1000. FIG. 2B illustrates an example of a hardware configuration of the plug-in server 6000.

It should be noted that the AI assistant server 4000 has a hardware configuration similar to the hardware configuration of the plug-in server 6000 illustrated in FIG. 2B. Further, the external system server 7000 has a hardware configuration similar to the hardware configuration of the computer 1000 illustrated in FIG. 2A. Accordingly, detailed descriptions thereof are omitted.

As illustrated in FIG. 2A, the computer 1000 includes a display unit 110, an operation unit 120, a storage unit 130, a control unit 140, and a network communication unit 150, and these components are connected to communicate with one another. The computer 1000 is, for example, a desktop or laptop personal computer (desktop or laptop PC), a tablet terminal, a smartphone, or the like. The control unit 140 includes a central processing unit (CPU) 141 and a memory 142 and controls the entire computer 1000.

The display unit 110 includes a display, such as a liquid crystal panel, and is configured to display an image, various screens, and the like. The operation unit 120 includes, for example, a mouse, a keyboard, and the like and is configured to receive an input operation performed by a user. It should be noted that a touch panel or the like that includes the function of the display unit 110 and the function of the operation unit 120 may be included.

The storage unit 130 includes a storage medium, such as a hard disk or a solid state drive (SSD), and stores various programs (software) and the like that are necessary when the computer 1000 operates. When necessary, the programs are loaded into the memory 142 and executed by the CPU 141. The programs include a program for causing the CPU 141 to execute each component or function of the application 2000.

It should be noted that the programs are not limited to the programs stored in the computer 1000. For example, the programs may be stored in an external apparatus capable of communicating with the computer 1000 configured to execute the application 2000, such as the AI assistant server 4000, the plug-in server 6000, or the external system server 7000. In that case, when executing a program, the computer 1000 communicates with the external apparatus, accesses the program, and executes processing.

The network communication unit 150 performs data input/output with an external apparatus via an external network. This enables the computer 1000 to exchange information with an external apparatus, such as the AI assistant server 4000 or the plug-in server 6000, via a network, such as the Internet 8000.

As illustrated in FIG. 2B, the plug-in server 6000 includes a display unit 610, an operation unit 620, a storage unit 630, a control unit 640, and a network communication unit 650, and these components are connected to communicate with one another.

The control unit 640 includes a CPU 641, a memory 642, and a graphics processing unit (GPU) 643 and controls the entire plug-in server 6000.

Detailed descriptions of components of the hardware configuration of the plug-in server 6000 that are similar to those of the hardware configuration of the computer 1000 are omitted.

The GPU 643 is a computation unit including an image processor. For example, the GPU 643 performs computation to transform an input image or input text data using an LLM based on a control command from the CPU 641.

It should be noted that the plug-in server 6000 and the AI assistant server 4000 configured to perform processing using generative AI can include the GPU 643, but the effect of the present disclosure can still be achieved without the GPU 643.

### Software Configuration

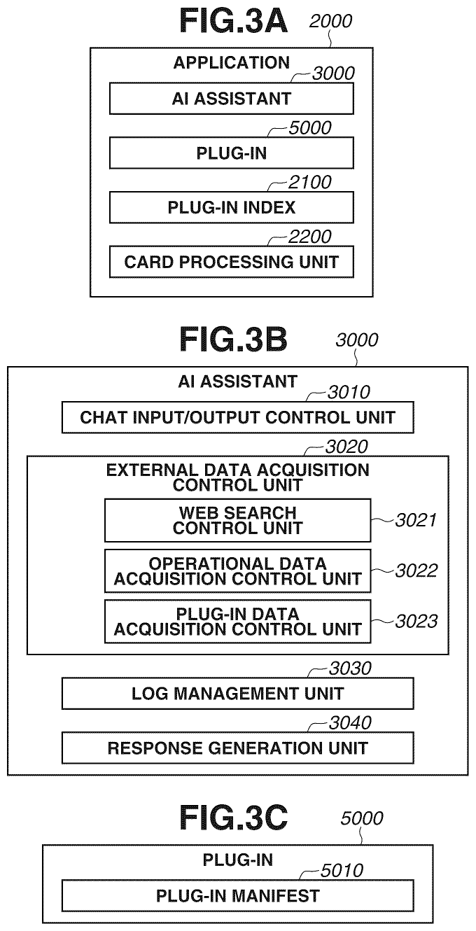

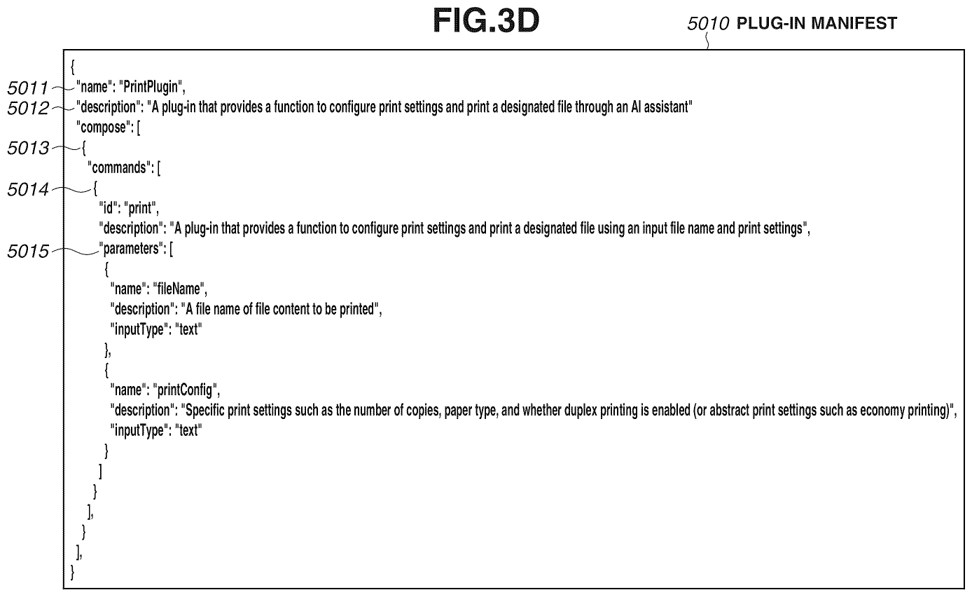

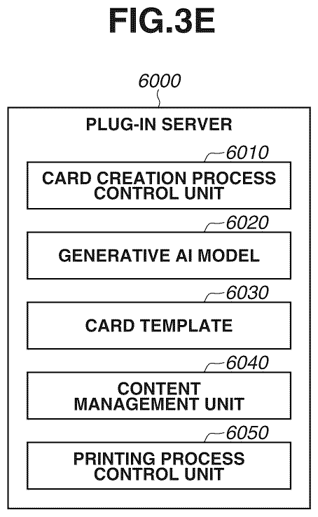

A software configuration of each apparatus according to the present embodiment will be described with reference to FIGS. 3A to 3E. FIG. 3A illustrates modules of the application 2000 related to processing of the AI assistant 3000 and the plug-in 5000. FIG. 3B illustrates modules of the AI assistant 3000 related to a response generation process that includes execution of the plug-in 5000. FIG. 3C illustrates a software configuration of the plug-in 5000. FIG. 3D illustrates an example of a plug-in manifest 5010 of the plug-in 5000. FIG. 3E illustrates a software configuration of the plug-in server 6000.

Software Configuration of the Application 2000

As illustrated in FIG. 3A, the application 2000 at least includes the AI assistant 3000, the plug-in 5000, a plug-in index 2100, and a card processing unit 2200. The application 2000 is not particularly limited and may be any application in which the AI assistant 3000 is installed. Examples include a communication tool, an email system, and document editing software. The communication tool herein may be an application configured to exchange a message using a chat service.

First, the AI assistant 3000 of the application 2000 includes a function that returns a response to the prompt 3100 in a case where the prompt 3100 is input to the AI assistant 3000.

The plug-in 5000 is software added to expand the function of the application 2000 and can provide, for example, a function that operates an external system, such as various storage services or a core system, through the application 2000. A plurality of plug-ins 5000 can be installed in the application 2000, and the maximum number of plug-ins 5000 that can be installed is determined by a specification of the application 2000. Furthermore, the plug-in 5000 can be invoked from the AI assistant 3000 and is used as reference information for generating a response to the prompt 3100 by the AI assistant 3000. It should be noted that a single plug-in 5000 may contain a plurality of commands, and the AI assistant 3000 may determine and invoke an appropriate command. Further, a method for invoking the plug-in 5000 is not particularly limited. For example, the plug-in 5000 may be configured to be invoked only from the application 2000. Either an invoking method in which the plug-in 5000 is invoked only from the AI assistant 3000 or an invoking method in which the plug-in 5000 supports both the application 2000 and the AI assistant 3000 may be employed.

The plug-in index 2100 is a list of plug-in information for each plug-in 5000 installed in the application 2000. In the plug-in information, metadata can be registered, including a name of the plug-in 5000, a description (natural language description), a parameter, and the like described in the plug-in manifest 5010 of the plug-in 5000. Further, it is also possible to register an identifier (ID) assigned by the application 2000 to manage the plug-in 5000. The AI assistant 3000 determines the plug-in 5000 to be executed based on the plug-in information.

### Software Configuration of the AI Assistant 3000

As illustrated in FIG. 3B, the AI assistant 3000 includes a chat input/output control unit 3010, an external data acquisition control unit 3020, a log management unit 3030, and a response generation unit 3040.

The chat input/output control unit 3010 includes a function that receives the prompt 3100 from the application 2000, and a function that transmits generated output to the application 2000 via the AI assistant server 4000. The format of the prompt 3100 input and output at that time is not limited to an natural language instruction, and it is also possible to attach file content, such as an image file or a document file.

The external data acquisition control unit 3020 includes several functions for acquiring additional information used by the response generation unit 3040 to generate a response with a generative AI model 6020. A web search control unit 3021 provides a function that acquires information available on the web via a search engine. An operational data acquisition control unit 3022 provides a function that acquires a document or information created during daily operations from a cloud storage or a core system linked to the application 2000. Further, a plug-in data acquisition control unit 3023 provides a function that links to an external system that is either unlinked or linked to the application 2000, and acquires information available on the external system. Details of the processing of the plug-in data acquisition control unit 3023 will be described below in an embodiment.

The log management unit 3030 includes a function that saves and provides, as an operation log, the prompt 3100 previously input to the AI assistant 3000 by the user and a response output by the AI assistant 3000. The operation log saved by the log management unit 3030 is used as information for parameter determination when the plug-in server 6000 is invoked, or for response generation by the AI assistant server 4000.

The response generation unit 3040 includes a function that communicates with the AI assistant server 4000 and generates a response to the prompt 3100 using an LLM. At that time, it is possible to use the information acquired as additional information by the external data acquisition control unit 3020, a conversation history performed on the AI assistant 3000, and other information that can be acquired from the application 2000. It should be noted that the other information that can be acquired from the application 2000 is not particularly limited, and examples include content posted by the user or a third party on the communication tool, file creator information and an update history in presentation software, and the like.

### Software Configuration of the Plug-In 5000

As illustrated in FIG. 3C, the plug-in 5000 at least includes the plug-in manifest 5010. The plug-in manifest 5010 is a file describing information regarding the plug-in 5000, is registered in the plug-in index 2100, and is used by the AI assistant 3000 as information for determining the plug-in 5000 to be executed. An example of the plug-in manifest 5010 will be described with reference to FIG. 3D. The plug-in manifest 5010 illustrated in FIG. 3D is file content in JavaScript Object Notation (JSON) format and contains information 5011 to information 5015. The information 5011 presents a setting describing a name of the plug-in 5000. The information 5012 presents a description (natural language description) of the plug-in 5000 and is referenced mainly when the AI assistant 3000 determines which plug-in is to be executed. For example, in a case where the prompt 3100 “Print 5 copies of Sample1.pdf using economy printing” is input, a keyword search or a concept search using AI may be performed against the description illustrated in FIG. 3D to determine whether to execute the plug-in 5000. The information 5013 presents a component of the plug-in 5000 and includes a command in the plug-in 5000 presented in the information 5014. The information 5014 presents the command included in the plug-in 5000, and in FIG. 3D, an ID, a description, and a parameter of each command are included. The information 5015 presents the parameter of each command, and in FIG. 3D, a parameter name, a description, and an input type are included. The information 5014 and the information 5015 each include a description, and the descriptions are referenced mainly when the AI assistant 3000 determines a parameter for creating a request to the plug-in server 6000. Further, a plurality of commands can be set for a single plug-in, and the maximum number of commands that can be set is determined by the specification of the application 2000.

The foregoing content is provided merely as an example, and the content of the plug-in manifest 5010 is not limited those described above. For example, developer information, a sample prompt, an application programming interface (API) definition of the plug-in 5000, an authentication method, and the like may be described. Further, the software configuration of the plug-in 5000 is not particularly limited and may include, for example, an icon image and/or an API definition file for performing an operation on the plug-in server 6000.

### Software Configuration of the Plug-In Server 6000

As illustrated in FIG. 3E, the plug-in server 6000 includes a card creation process control unit 6010, the generative AI model 6020, a card template 6030, and a content management unit 6040.

The card creation process control unit 6010 includes a function that controls a process performed by the plug-in server 6000 invoked by the AI assistant 3000 using the plug-in 5000. Details of processing performed by the AI assistant server 4000 will be described below with reference to an embodiment. Examples include an operation on an external system other than the plug-in server 6000, an operation on the generative AI model 6020, an operation on the external system, an operation on the generative AI model 6020, and the like. Further, other examples include a process of creating the card 3200 based on the card template 6030 using the results of these operations and transmitting the created card 3200 to the application 2000 or the AI assistant 3000, and the like.

The generative AI model 6020 is a type of machine learning model trained using a large dataset and a type of AI capable of creating original content.

Examples include an LLM suitable for natural language processing, generative adversarial Networks (GAN) suitable for image processing, and the like. The plug-in server 6000 may include another generative AI model 6020. Further, the generative AI model 6020 is not limited to existing within the plug-in server 6000 and may be a component of the external system server 7000 located outside the plug-in server 6000.

The card template 6030 is a template for the card 3200 transmitted to the AI assistant 3000. The card 3200 to be posted on the AI assistant 3000 can be created by applying a parameter generated during processing in the card creation process control unit 6010. Furthermore, the card template 6030 is configured not only to simply display an output result of the plug-in server 6000 but also to receive user operations on the application 2000 or the AI assistant 3000. For example, an operation may be performed on the plug-in server 6000 via the card 3200 displayed on the AI assistant 3000, and the card 3200 may be updated based on the operation result. Further, the card template 6030 may be a single file, or a plurality of files may be included and the card template 6030 to be used may be selected based on the prompt 3100. It should be noted that the card template 6030 may be present on the plug-in server 6000 or may be present as part of the plug-in 5000 installed in the application 2000. In the latter case, the application 2000 or the AI assistant 3000 is required to perform a process of applying a parameter received from the plug-in server 6000 to the card template 6030 and creating the card 3200, instead of the plug-in server 6000.

The content management unit 6040 includes a function that manages file content on the plug-in server 6000. The file content managed by the content management unit 6040 is not particularly limited. Examples include an attached file 3130 attached to the prompt 3100 on the AI assistant 3000 and a file acquired from the external system server 7000 by the card creation process control unit 6010 using the plug-in information. Further examples include a file generated by the generative AI model 6020 and the like.

### Example of a User Interface (UI) for Posting a Card

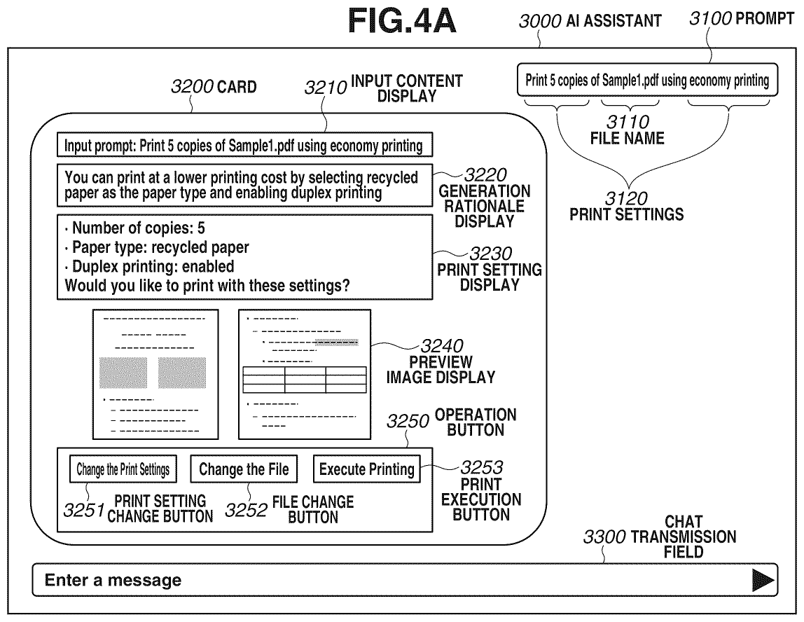

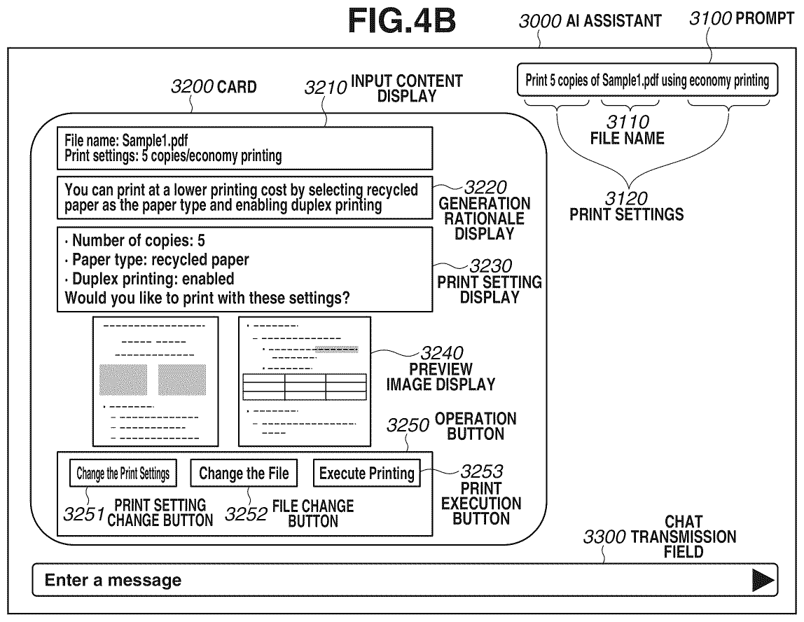

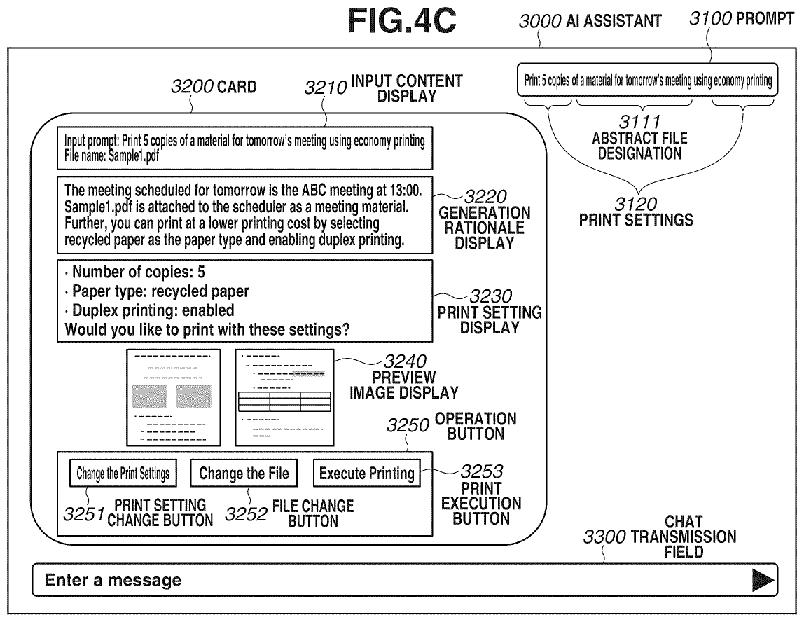

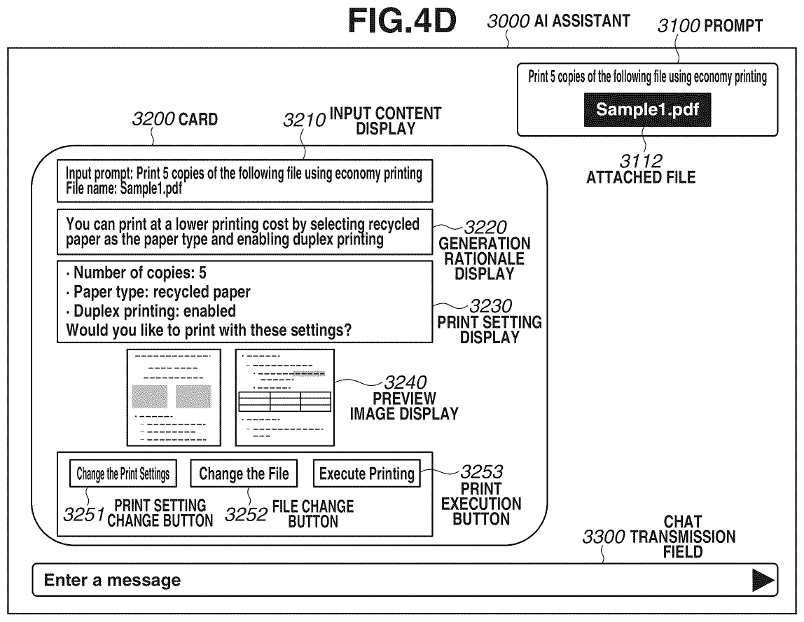

An example of a UI for posting a card according to the present embodiment will be described with reference to FIGS. 4A to 4D. The prompt 3100, the card 3200, and a chat transmission field 3300 are displayed on each screen of the AI assistant 3000 illustrated in FIGS. 4A to 4D. It should be noted that the prompt 3100 is a prompt posted on the AI assistant 3000 by the user, and the card 3200 is a card returned to the AI assistant 3000 by the plug-in server 6000.

Further, the chat transmission field 3300 is an example of an input field and is used by the user to post the prompt 3100 on the AI assistant 3000. The user inputs a natural language into the chat transmission field 3300 to configure a setting used during file printing, and the AI assistant 3000 receives the input natural language.

Furthermore, the user can post a file using the chat transmission field 3300, and the AI assistant 3000 acquires the posted file. It should be noted that when specifying the file, the user may post the file alone, post the file attached to text, or post a character string indicating a location of the file, such as a uniform resource locator (URL).

While the plug-in 5000 configured to provide a function that prints file content designated by the user using a print setting set by the user via the AI assistant 3000 will be described as an example, the display of the card 3200 for performing the foregoing process and the like are not particularly limited.

The plug-in 5000 requests at least two parameters, a file name 3110 and a print setting 3120, as input to the plug-in server 6000. It should be noted that the file name 3110 is a file name of the file content to be printed, and the print setting 3120 is a specific print setting, such as the number of copies, paper type, or whether duplex printing is enabled/disabled (or an abstract print setting, such as economy printing).

The plug-in server 6000 enabled by the plug-in 5000 to communicate includes a function that acquires file content to be printed from the external system server 7000, such as a cloud storage. The plug-in server 6000 further includes a function that generates the print setting 3120, a function that creates a preview image by applying the generated print setting 3120 to the acquired file content, and a function that returns the card 3200 describing the generated print setting 3120 and the preview image.

The plug-in 5000 creates the card 3200 including a print setting and/or a preview image based on the prompt 3100 including the file name 3110 and the print setting 3120 and posts the card 3200 to the AI assistant 3000. Then, the user can use the card 3200 to perform an interaction, such as changing a print setting or a printing target or issuing a print instruction, using information stored in the card 3200.

At that time, the results of each interaction and process execution are displayed by updating the previously posted card 3200, instead of posting a new card 3200, thereby preventing an increase in the number of unnecessary chat posts caused by a plurality of interactions. Accordingly, an effect is achieved in which the operability and visibility of the application 2000 for the user are improved.

Further, in a case where a different printing target is printed using a different setting, the user inputs the prompt 3100 again into the chat transmission field 3300 and invokes the plug-in 5000, whereby a different new card is posted. The user can perform a new interaction using the newly posted card 3200. It should be noted that hereinafter, the plug-in 5000 may also be referred to as “the print plug-in”, the plug-in server 6000 as “the print plug-in server”, and the external system server 7000 as “the cloud storage”.

According to the present embodiment, the card 3200 includes an input content display 3210, a generation rationale display 3220, a print setting display 3230, a preview image display 3240, and an operation button 3250. Further, the operation button 3250 includes a print setting change button 3251, a file change button 3252, and a print execution button 3253.

The card 3200 is an object that is displayed in a case where a file is acquired and a setting is received based on a natural language input into the chat transmission field 3300. As illustrated in FIGS. 4A to 4D, the card 3200 does not include the chat transmission field 3300, and the card 3200 and the chat transmission field 3300 are displayed independently in separate areas.

The prompt 3100 posted to the AI assistant 3000 by the user will be described.

In FIG. 4A, a natural language instruction, “Print 5 copies of Sample1.pdf using economy printing”, is input as the prompt 3100 by the user (the same prompt 3100 is input in FIG. 4B).

The AI assistant 3000 analyzes the prompt 3100 input (posted) by the user, and in a case where the AI assistant 3000 determines that it is appropriate to execute the print plug-in, the AI assistant 3000 invokes the print plug-in server. At that time, the AI assistant 3000 extracts information of the file name 3110, “Sample1.pdf”, and information of the print setting 3120, “print 5 copies using economy printing”, from the prompt 3100 based on the parameter specifications described in the plug-in manifest 5010.

These two pieces of information are passed from the AI assistant 3000 to the print plug-in server and used by the card creation process control unit 6010 during its processing.

It should be noted that the prompt 3100 input by the user is not limited to the above-described example. For example, as illustrated in FIG. 4C, the user may use an abstract file designation, “Print 5 copies of a material for tomorrow's meeting using economy printing”, to specify a printing target and invoke the print plug-in. In that case, the operational data acquisition control unit 3022 of the AI assistant 3000 searches for a material corresponding to “a material for tomorrow's meeting” and passes the material when the print plug-in server is invoked. Alternatively, it is necessary for the card creation process control unit 6010 of the print plug-in server to perform a process, such as searching for a material corresponding to “a material for tomorrow's meeting” from the cloud storage.

Alternatively, as illustrated in FIG. 4D, the user may input a combination of a natural language and file content by attaching a file to the prompt 3100 and inputting “Print 5 copies of the following file using economy printing”. Furthermore, in a case where the application 2000 in which the AI assistant 3000 is installed is an application configured to provide a file editing function, such as document editing software or presentation software, the following process may be performed. The AI assistant 3000 may receive the instruction “Print 5 copies of the file itself using economy printing”, pass information for determining “the file itself” held by the application 2000 to the print plug-in server, and cause the print plug-in server to process the information. It should be noted that the information for determination refers to the file name 3110, a file ID, and the like.

Next, the card 3200 returned (posted) by the print plug-in server will be described. In the examples illustrated in FIGS. 4A to 4D, the card 3200 displays the input content display 3210, the generation rationale display 3220, the print setting display 3230, the preview image display 3240, and the operation button 3250.

The input content display 3210 displays the prompt input into the chat transmission field 3300 and posted by the user. Specifically, the content transmitted from the AI assistant 3000 to the print plug-in server when the print plug-in is invoked is displayed, and the user can confirm the content.

In the example illustrated in FIG. 4A, the prompt 3100 posted by the user, “Input prompt: Print 5 copies of Sample1.pdf using economy printing”, is directly displayed in the input content display 3210. However, the content displayed in the input content display 3210 is not limited to the above-described content.

For example, as illustrated in FIG. 4B, parameters “File name: Sample1.pdf” and “Print settings: 5 copies/economy printing” extracted from the prompt 3100 and transmitted to the print plug-in server may be displayed in place of the prompt 3100 actually input. Further, as illustrated in FIG. 4C, the file name 3110 searched and inferred based on the abstract file designation may be displayed as in “Input prompt: Print 5 copies of a material for tomorrow's meeting using economy printing” and “File name: Sample1.pdf”. It should be noted that displaying the input content display 3210 is not required, and a configuration may be employed in which the input content display 3210 is not displayed.

The generation rationale display 3220 and the print setting display 3230 display parameters generated by the print plug-in server using the generative AI model 6020.

In the example illustrated in FIG. 4A, the generation rationale display 3220 displays “You can print at a lower printing cost by selecting recycled paper as the paper type and enabling duplex printing”, and the print setting display 3230 displays “Number of copies: 5”, “Paper type: recycled paper”, “Duplex printing: enabled”, and “Would you like to print with these settings?”.

The content displayed in the generation rationale display 3220 and the content displayed in the print setting display 3230 are not limited to the above-described content. For example, as in the example illustrated in FIG. 4C, the basis for inference from the abstract file designation may be indicated in addition to the reason for generating the print setting 3120, as in “The meeting scheduled for tomorrow is the ABC meeting at 13:00. Sample1.pdf is attached to the scheduler as a meeting material.”.

The preview image display 3240 displays an image (preview image) obtained by applying the print setting 3120 generated by the generative AI model 6020 to the printing target designated by the file name 3110 or the like, as in the example illustrated in FIG. 4A. Accordingly, the user can verify whether the content specified in the prompt 3100, such as a print setting, is reflected as intended by the user.

As described above, the card 3200 may simply display the content generated by the plug-in server 6000 using the generative AI model 6020 and may further display the result of performing another process using the content.

The operation button 3250 displays an additional button used by the user to perform an additional operation after verifying the content. In the example illustrated in FIG. 4A, the print setting change button 3251, the file change button 3252, and the print execution button 3253 are included.

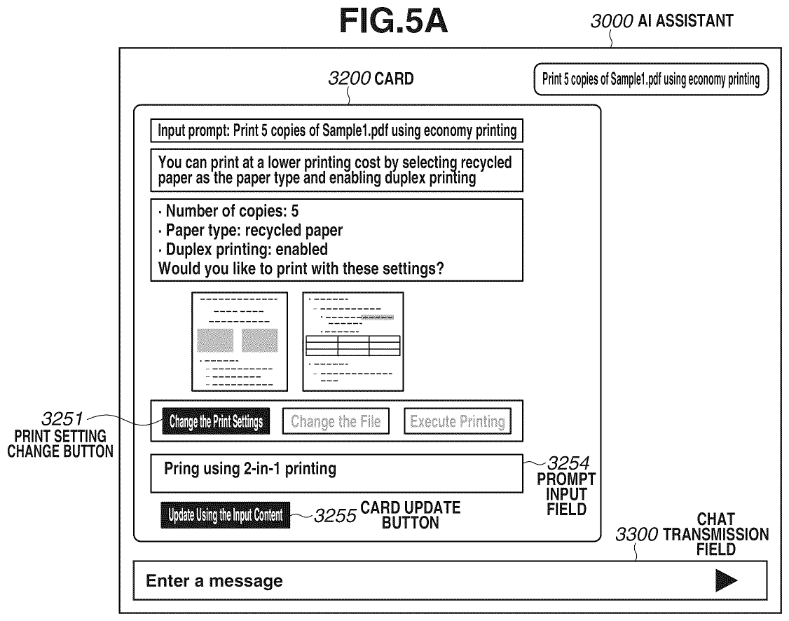

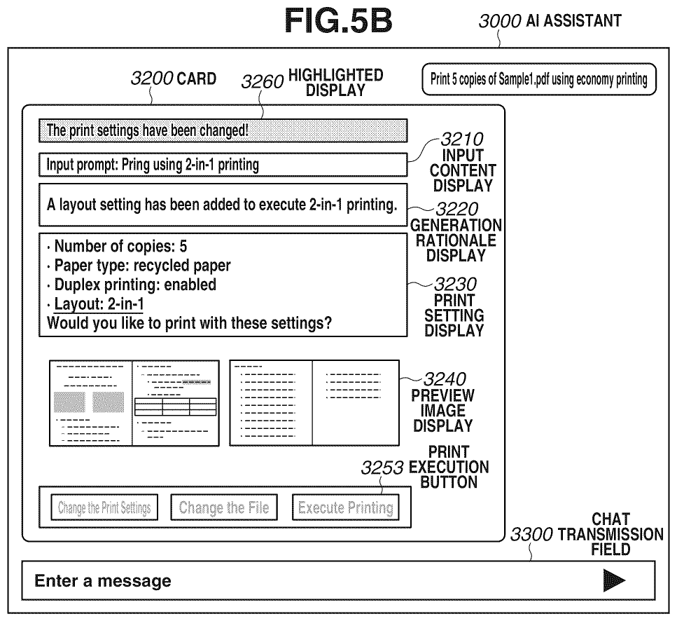

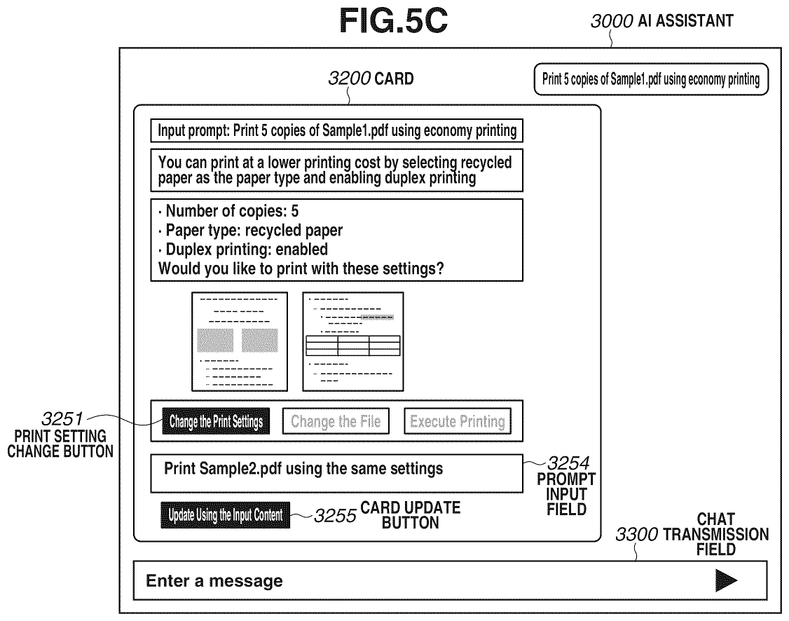

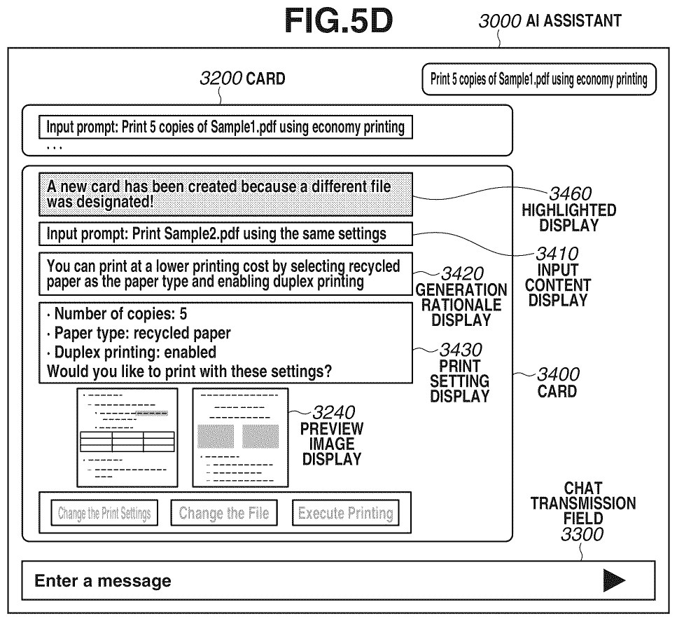

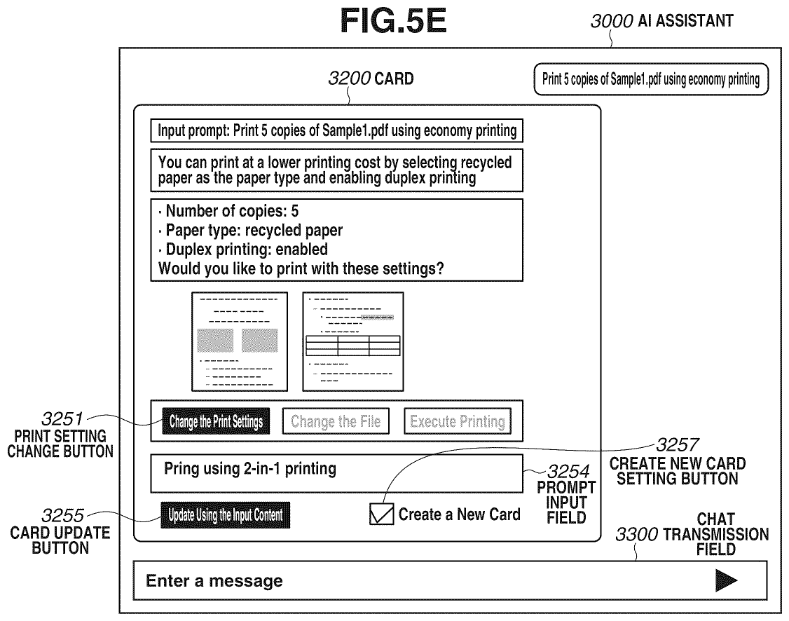

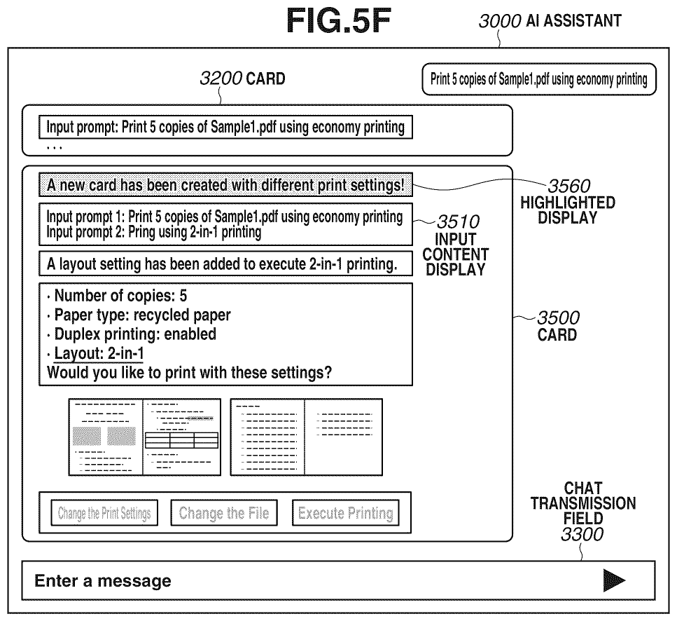

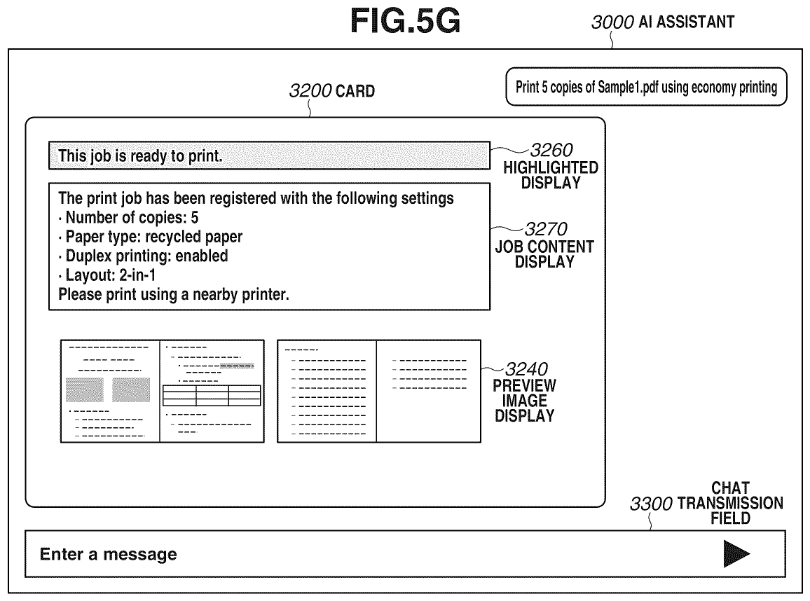

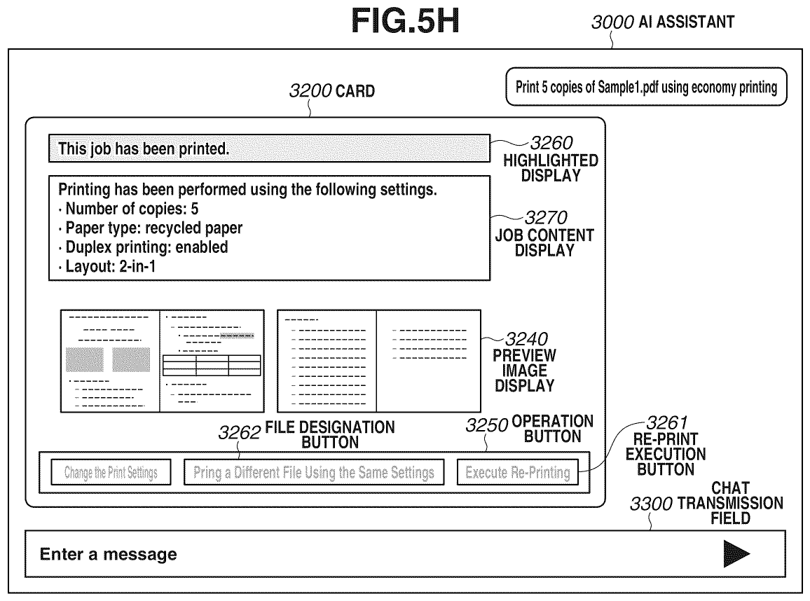

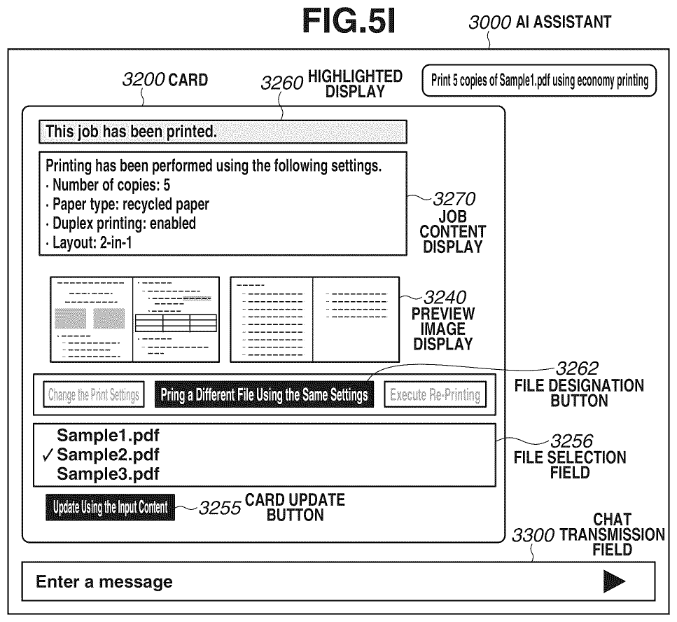

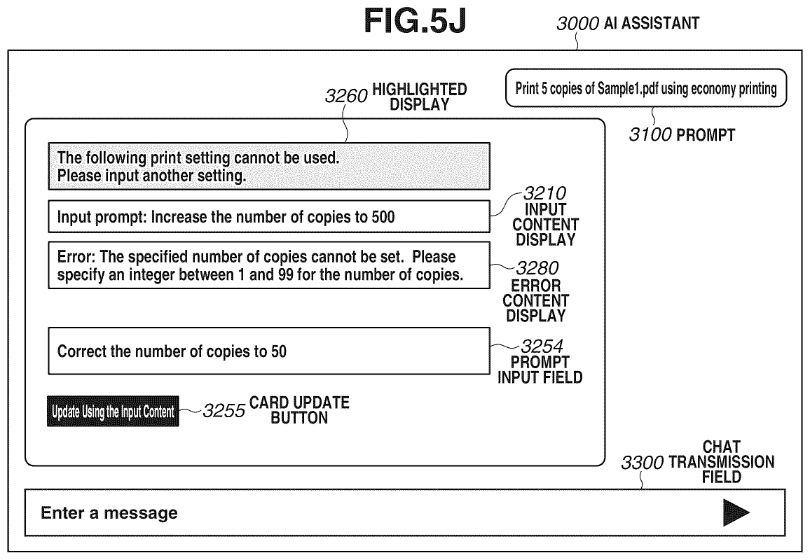

When pressed, the print setting change button 3251 provides a function in which the CPU 141 receives the additional prompt 3100 input by the user and regenerates the print setting 3120 (the function will be described below with reference to FIG. 5A). When pressed, the file change button 3252 provides a function in which the CPU 141 receives re-selection of a file by the user and changes the printing target. When pressed, the print execution button 3253 provides a function in which the CPU 141 submits a print job to a printer based on the content displayed on the card 3200.

It should be noted that each card 3200 may display one or more operation buttons 3250, and the maximum number of buttons that can be displayed is determined by the specification of the application 2000.

Examples of screens displayed in a case where the card 3200 is posted are described above with reference to FIGS. 4A to 4D. As described above, even in a case where the same file is printed with the same setting, the elements displayed on the card 3200 and how the elements are displayed may vary depending on how the prompt 3100 is written.

The examples illustrated in FIGS. 4A to 4D share the characteristic that the same file “Sample1.pdf” is printed with the same settings “Number of copies: 5”, “Paper type: recycled paper”, and “Duplex printing: enabled”. It is also possible to employ a configuration in which the display is always performed using the single pattern described above.

Further, while the description of FIGS. 4A to 4D is based on the assumption that the card 3200 associated with a single print job is posted based on the single prompt 3100, the number of cards 3200 that the plug-in server 6000 can post at a time is not particularly limited.

For example, the card 3200 may be posted for each file in response to the prompt 3100 such as “Suggest the optimal print setting 3120 for Sample1.pdf/Sample2.pptx”. In that case, the user can configure print settings on each card 3200 for its corresponding file.

### Examples of a Card Update UI

Examples of a screen (UI) for updating the card 3200 according to the present embodiment will be described with reference to FIGS. 5A to 5J. For the purpose of description, FIGS. 5A to 5J are based on the assumption that the prompt 3100 and the card 3200 illustrated in FIG. 4A are posted. It should be noted that selecting the operation button 3250 for updating the card 3200 in the following description refers to a general user operation for executing a desired operation, such as clicking a mouse or pressing an Enter key of a keyboard to select a button.

### Example of a Card Update UI for Changing the Print Setting

To change the print setting 3120 generated by the print plug-in server, the user may select the print setting change button 3251 on the card 3200 and generate a different print setting.

FIG. 5A illustrates an example of the card 3200 on which a prompt input field 3254 and a card update button 3255 are displayed upon selecting the print setting change button 3251.

The prompt input field 3254 and the card update button 3255 are elements that remain hidden upon initial posting of the card 3200 (FIG. 4A), and are displayed upon selecting the print setting change button 3251.

The prompt input field 3254 is a field into which the user can input a natural language prompt, and the user can input a prompt using the operation unit 120, a software key (not illustrated), or the like. The AI assistant 3000 receives the natural language input into the prompt input field 3254 by the user and uses the received natural language to configure the setting for file printing.

For example, FIG. 5A illustrates an example of a state where a prompt indicating “Print using 2-in-1 printing” is input by the user. While the content of a prompt that can be input into the prompt input field 3254 is not particularly limited, the number of characters that can be input and whether a file can be attached are determined by the constraints of the plug-in 5000 and the application 2000.

Upon completion of inputting a prompt into the prompt input field 3254, the user selects the card update button 3255. When the card update button 3255 is selected, a request including the current print setting and file name held by the card 3200 and the prompt input into the prompt input field 3254 is transmitted to the print plug-in server. As a result, a re-print setting is generated using the generative AI model 6020, and the card 3200 is updated based on the result.

In other words, at that time, the displayed content and print setting of the previously posted card 3200 are updated based on the prompt input by the user, instead of posting a new card. It should be noted that a configuration may be employed in which a print setting corresponding to the prompt input by the user and the like are displayed on a new card.

FIG. 5B illustrates an example of the card 3200 updated upon selecting the card update button 3255 in FIG. 5A. In FIG. 5B, the input content display 3210, the generation rationale display 3220, the print setting display 3230, and the preview image display 3240 are updated based on the prompt “Print using 2-in-1 printing” input in FIG. 5A. Furthermore, a highlighted display 3260 displaying “The print settings have been changed!” indicating details of the executed operation is added as a new element of the card 3200.

At that time, as the preview image has been updated, the preview image to which the setting based on the prompt input initially by the user is applied is hidden. It should be noted that a configuration may be employed in which the preview image prior to the update is continued to be displayed to indicate the state before and after the update.

In a case where the user inputs “Print using 4-in-1 printing” into the prompt input field 3254, the input content display 3210, the generation rationale display 3220, the print setting display 3230, and the preview image display 3240 are updated based on the input prompt. Further, in a case where not only the print setting but also, for example, the number of copies are designated by the user, an item corresponding to the designated number of copies is updated.

For example, in a case where the user inputs “Print 6 copies” into the prompt input field 3254, the highlighted display 3260 displays, for example, “The number of copies has been changed!”. Further, the input content display 3210 displays, for example, “Input prompt: Print 6 copies”, and the generation rationale display 3220 displays, for example, “The setting value for the number of copies has been changed in response to the designated number of copies”. Furthermore, the content of the print setting display 3230 is updated from “the number of copies: 5 copies” displayed prior to the selection of the card update button 3255 by the user, as illustrated in FIG. 5A, to “the number of copies: 6 copies” (not illustrated).

At that time, a configuration may be employed in which the character string “6 copies” is displayed while the character string “5 copies” is hidden. In other words, a configuration may be employed in which in a case where a print setting is changed by the user as described above, the print setting prior to the change is hidden while the print setting after the change is displayed. It should be noted that both the print setting prior to the change and the print setting after the change may be displayed. Further, the print setting display may correspond to all of the plurality of setting items or to the changed setting item.

### Example of a New Card Generation UI Displayed When a Print Setting is Changed

Next, an example will be described in which in a case where the user wishes to apply a print setting generated by the print plug-in server to printing a different file, the user selects the print setting change button 3251 on the card 3200 and applies the print setting 3120 to the different file.

FIG. 5C illustrates an example in which the prompt input into the prompt input field 3254 is different from that in FIG. 5A. In FIG. 5C, “Print Sample2.pdf using the same settings” is input.

Then, when the user executes the card update button 3255, a request including the current print setting and file name held by the card 3200 and the prompt input into the prompt input field 3254 is transmitted to the print plug-in server. Upon receiving the request, the print plug-in server determines whether to update the card 3200 or to generate a new card 3400 using the generative AI model 6020. As the file (Sample2.pdf) designated herein is different from the current printing target file (Sample1.pdf), the print plug-in server determines to generate the new card 3400. Subsequently, the new card 3400 is generated based on the prompt (in particular, designated file information) and the print setting, and the card 3400 is posted based on the result. In other words, it is determined whether the file designated in the prompt input into the prompt input field 3254 of the card 3200 is different from the file designated as the printing target on the card 3200. In a case where it is determined that the designated file is a different file, the new card 3400 different from the card 3200 is generated and posted to the chat field. The print setting associated with the card 3400 (the print setting associated with Sample2.pdf) is based on the prompt input into the prompt input field 3254 of the card 3200. In the examples illustrated in FIGS. 5C and 5D, as “using the same settings” is input, the same print setting configured for the card 3200 is also configured for the card 3400.

Further, in FIGS. 5C and 5D, the card 3400, which is a second object, is displayed upon inputting a natural language indicating an instruction to print Sample2.pdf, which is a second file. At that time, the card 3400 is displayed in a state where the card 3200, which is a first object, and the chat transmission field 3300 (another input field) are displayed.

Further, in a case where a natural language indicating an instruction to change the print setting for Sample1.pdf, which is the first file, is input into the prompt input field 3254 of the card 3200 (in a case where the input is not an instruction to print a different file), no new object, such as the card 3400, is displayed.

Instead, the updated card 3200 is displayed as illustrated in FIG. 5B.

It should be noted that FIGS. 5C and 5D illustrate an example of a case where a natural language indicating an instruction to print a different file is input into the prompt input field 3254 of the card 3200. It is also possible to post a different object, such as the card 3400, to a talk room in a case where “Print Sample2.pdf using duplex printing” is input into the chat transmission field 3300. At that time, however, a new object (card) is generated and posted (displayed) upon input into the chat transmission field 3300, regardless of whether a different file is designated. In other words, there is a plurality of input fields into which the user can input a natural language on the screen, which may cause the user to erroneously input an instruction to print a different file into the prompt input field 3254 of the card 3200.

The present disclosure makes it possible to generate a new card and post and display the new card even in the foregoing case.

FIG. 5D illustrates an example of the card 3400 posted upon inputting a prompt into the prompt input field 3254 and pressing the card update button 3255 in FIG. 5C. In FIG. 5D, the card 3400 is displayed separately from the card 3200. As the card 3400 has a configuration similar to the configuration of the card 3200 illustrated in FIG. 5B, only the difference will be described. An input content display 3410 displays the prompt 3100 input into the prompt input field 3254 and may also display information of the input content display 3210. A preview image display 3440 displays a print preview image obtained by applying a print setting 3430 to the printing target file designated by the file name included in the prompt input into the prompt input field 3254 in FIG. 5C. Furthermore, a highlighted display 3460 displays “A new card has been created because a different file was designated!”, which indicates details of the executed operation.

It should be noted that, unlike the example illustrated in FIGS. 5A and 5B, the card 3200 is not updated for the print setting or the like. At that time, the prompt input field 3254 and the card update button 3255 may be hidden again as non-displayed elements upon executing the card update button 3255.

With the foregoing configurations, the user can configure a print setting and perform printing for a different file based on the same print setting. Further, the user may compare the cards 3200 and 3400 and verify the print results.

While FIGS. 5C and 5D illustrate an example in which a new card is generated based on the condition that a file different from the initial printing target is designated, a new card may be generated based on a different condition. In FIG. 5E, a create new card setting button 3257 via which the user may designate whether to generate a new card is further displayed. In FIG. 5E, “Print using 2-in-1 printing” is input into the prompt input field 3254, as in FIG. 5A. At that time, upon executing the card update button 3255 with the create new card setting button 3257 in an enabled state, a new card 3500 is posted as illustrated in FIG. 5F, instead of updating the card 3200. The card 3500 has a configuration similar to the configuration of the card 3200 or 3400, so that detailed descriptions thereof are omitted. In the illustrated example, an input content display 3510 displays the two input prompts. Further, a highlighted display 3560 displaying “A new card has been created with different print settings!” indicating details of the executed operation is also displayed.

For convenience, the card 3200 is partially omitted from display in FIG. 5F. However, the card 3200 may be fully displayed as illustrated in FIG. 5E.

With the foregoing configurations, the user can compare the cards 3200 and 3500 and compare and verify the print results obtained by applying different print settings to the same file.

While FIGS. 5C to 5F illustrate examples in which a new card is generated, a new card may be generated based on another condition. Examples include a case where a prompt that indicates that the user intends to compare and verify the print results is input into the prompt input field 3254, such as “Compare it with a setting that can print while further reducing paper usage”. Further, a configuration may be employed in which a new card (a plurality of new cards) is created also in a case where the user inputs a request to present a plurality of print results, such as “Present two candidate print settings that can print while further reducing paper usage”.

### Example of a Card Update UI for Performing Printing

An example of a card update UI displayed in a case where a print job is submitted will be described with reference to FIG. 5G. It should be noted that an example will be described in which the print execution button 3253 in FIG. 5B is executed.

In a case where the user confirms the print setting and the printing target displayed on the card 3200 and wishes to perform printing, the user executes the print execution button 3253 on the card 3200, thereby submitting a print jot to the printer through processing performed by the print plug-in server. In FIG. 5G, the card 3200 indicating that a print job has been submitted is displayed upon executing the print execution button 3253. In FIG. 5G, a job content display 3270 is displayed, in addition to the highlighted display 3260 and the preview image display 3240, to display the print job that is ultimately submitted to the printer. It should be noted that in FIG. 5G, the operation button 3250 is hidden because the card 3200 corresponds to a state where the print job is submitted and the print plug-in server and the connected printer assume processing control. The display of the card 3200 is not limited to the above-described display. For example, a function that displays the operation button 3250 such as “Cancel printing” and cancels the submitted print job may be provided.

Furthermore, even in a case where the card 3200 is not operated by the user, the card 3200 may be updated through processing performed by the plug-in server 6000. In FIG. 5H, the card 3200 updated upon actual printing being performed by the printer is displayed. In FIG. 5H, the highlighted display 3260 and the job content display 3270 are updated from FIG. 5G, and the operation button 3250 is further displayed. The operation button 3250 displays the print setting change button 3251, a file designation button 3262, and a re-print execution button 3261. The file designation button 3262 receives an instruction print a different file using the same setting. The re-print execution button 3261 includes a function similar to the function of the print execution button 3253.

FIG. 5I illustrates the card 3200 on which a file selection field 3256 in a scrollable format and the card update button 3255 are displayed upon executing the file designation button 3262. It should be noted that a process of acquiring each file displayed in the file selection field 3256 is not particularly limited. For example, information acquired by the print plug-in server by accessing an external service may be displayed, or the display may be performed in association with the operational data acquisition function of the application 2000 (or the AI assistant 3000) as a function of the card 3200. Upon executing the card update button 3255, a request including the file designated in the file selection field 3256 and the print setting specified in the job content display 3270 is transmitted to the print plug-in server. A new card (not illustrated) different from the card 3200 is posted based on new card information returned based on the request.

With the foregoing configurations, the user can configure a print setting and perform printing for a different file based on the same print setting even after printing has been performed.

It should be noted that a configuration may be employed in which a new card is posted instead of updating the card 3200 in a case where the user executes the print setting change button 3251, inputs a prompt into the displayed prompt input field 3254, and executes the card update button 3255 in FIGS. 5H and 5I. With this configuration, even in a case where the same file is to be printed with a different print setting, since the card 3200 for which printing has been performed remains displayed (without being updated), it is possible to refer to the card 3200 as a record of printing or to compare the card 3200 with the new card.

### Example of a Card Update UI Displayed When an Error Occurs

Further, in a case where the print setting 3120 designated in the prompt 3100 is inappropriate, the card 3200 displaying information indicating that the prompt 3100 is inappropriate may be displayed. FIG. 5J illustrates an example of the card 3200 updated in a case where the inappropriate prompt 3100 “Increase the number of copies to 500” is input into the prompt input field 3254 in FIG. 5A.

The card 3200 includes the highlighted display 3260, the input content display 3210, an error content display 3280, the prompt input field 3254, and the card update button 3255. In particular, the error content display 3280 displays “Error: The specified number of copies cannot be set. Please specify an integer between 1 and 99 for the number of copies.”, indicating the cause of the error and a method for handling the error. Further, FIG. 5J has a characteristic that, unlike FIGS. 5A to 5I, the preview image display 3240 is not present on the card 3200. Accordingly, in the following description, the card 3200 with the preview image display 3240 may also be referred to as a preview card, and the card 3200 without the preview image display 3240 may also be referred to as an error card. The preview card and the error card may be created from different card templates 6030 or from the same card template 6030. Further, a plurality of card templates 6030 may be selectively used for the preview and error cards depending on the purpose. It should be noted that a condition for creating an error card is not particularly limited, and examples include a condition in which designated file content does not exist and a condition in which the prompt 3100 not associated with printing is input.

Examples of UIs displayed when a card is created or updated have been described with reference to FIGS. 4A to 5J. It should be noted that the card UIs are not limited to those described above and may be implemented in various formed based on a specification of the plug-in 5000. The display may be changed based on user input or a response from the generative AI. For example, in a case where “Pring @Sample1.pptx” is input (without designating a print setting), a frequently-used print button may be displayed, such as “Economy printing”, “Conference material”, or “Poster printing”. Further, the display may be changed depending on a terminal executing the application 2000. For example, the size of the preview image display 3240 may be adjusted on a mobile terminal.

### Sequence Example

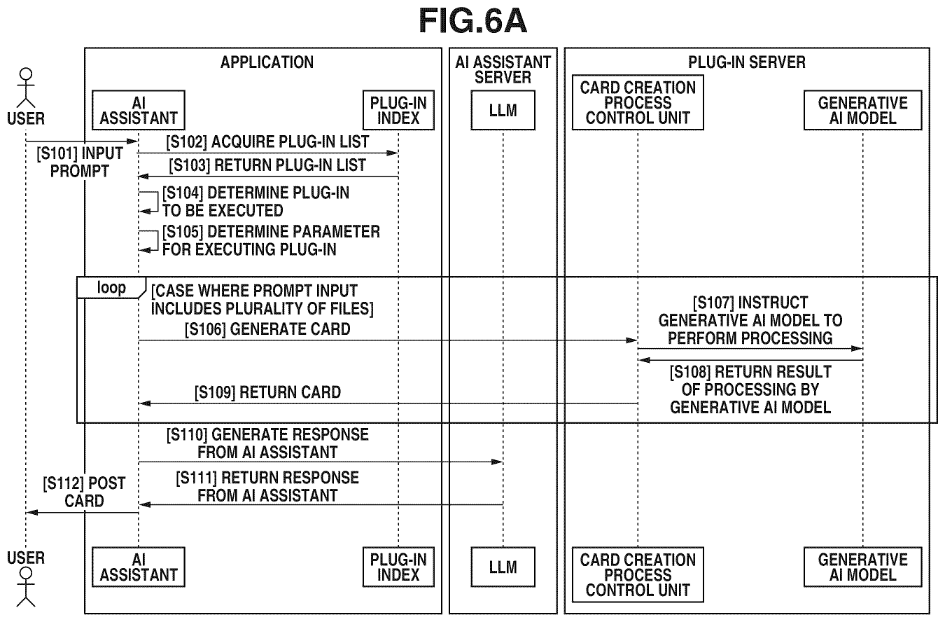

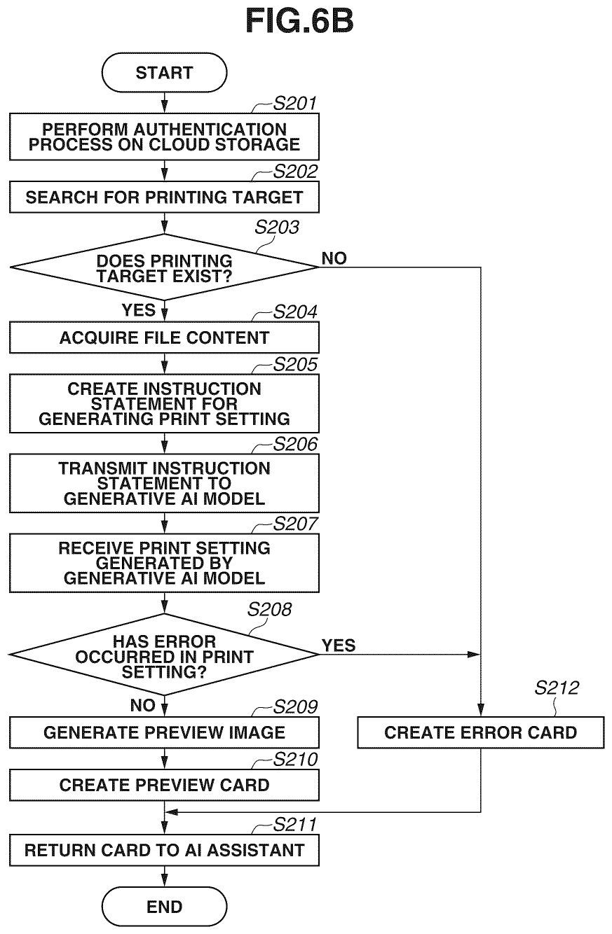

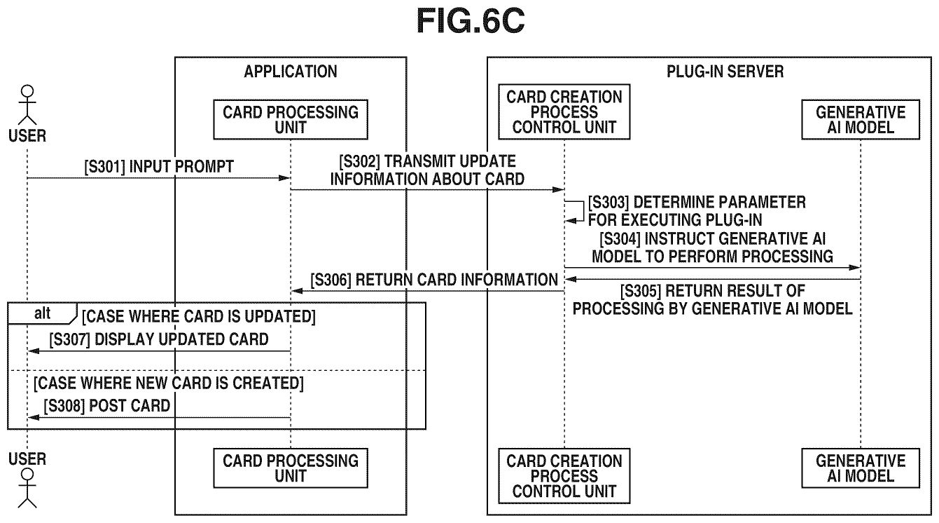

A processing flow in which the card 3200 is posted by the CPU 141 of the computer 1000 according to the present embodiment will be described with reference to FIGS. 6A to 6C. The letter “S” in the following description indicates a processing step, and a number following the letter “S” indicates a step number. It should be noted that the application 2000 operates under control of the CPU 141 of the computer 1000.

### Plug-In Invoking Sequence Executed When a Card is Created

A sequence in which the CPU 141 controls each component, invokes the plug-in 5000, and posts the card 3200 will be described with reference to FIG. 6A. It should be noted that the functions of the application 2000 and the AI assistant 3000 are executed by the CPU 141. Further, the computer 1000, the AI assistant server 4000, and the plug-in server 6000 are respectively controlled by their CPUs and are enabled to communicate with one another by their network communication units.

In step S101, the CPU 141 controlling the application 2000 receives the prompt 3100 input by the user.

In step S102, the AI assistant 3000 controlled by the CPU 141 requests a list of plug-ins 5000 registered in the application 2000 from the plug-in index 2100.

In step S103, the plug-in index 2100 controlled by the CPU 141 returns the list of plug-ins 5000 requested by the AI assistant 3000, whereby the AI assistant 3000 receives (acquires) the list of plug-ins 5000. It should be noted that in a case where the plug-in index 2100 is a database, the AI assistant 3000 may be configured to refer to the plug-in index 2100 and acquire the list of plug-ins 5000.

In step S104, the AI assistant 3000 controlled by the CPU 141 determines a plug-in 5000 to be executed in response to the user instruction input as the prompt 3100. For example, the AI assistant 3000 performs this determination by referring to a description of each plug-in (natural language description regarding each plug-in) and performing a keyword search or a concept search using AI based on the prompt 3100 input by the user.

Another specific example will be described. The AI assistant 3000 controlled by the CPU 141 first performs a concept search between the prompt 3100 input by the user in step S101 and a print plug-in description, such as the information 5012 illustrated as an example in FIG. 3D. In a case where there is a plurality of candidates, each plug-in 5000 is searched and evaluated, and in a case where the results indicate that a predetermined rank or score is met, the AI assistant 3000 determines that it is appropriate to execute the print plug-in.

Further, in a case where there is a plurality of appropriate plug-ins 5000, the AI assistant 3000 may perform the processes for each plug-in 5000 or for a selected one of the plug-ins 5000. On the other hand, in a case where there is no appropriate plug-in 5000, the processes for the plug-in 5000 may not be performed.

Furthermore, a plurality of commands may be included in a single plug-in 5000, and the AI assistant 3000 may refer to a description set for each command and determine the plug-in 5000 on a per-command basis. Once the AI assistant 3000 controlled by the CPU 141 determines the plug-in 5000 to be executed and a command of the plug-in 5000, the processing proceeds to step S105.

In step S105, the AI assistant 3000 controlled by the CPU 141 determines a parameter for executing the plug-in 5000. For example, the AI assistant 3000 determines a parameter based on the prompt 3100, an operation log, and other information that can be acquired by the AI assistant 3000. Furthermore, at that time, the AI assistant 3000 refers to a description of each parameter and performs parameter extraction or generation using generative AI. It should be noted that the operation log is, for example, a log managed by the AI assistant 3000.

For example, in the parameter determination, parameter extraction is performed from the prompt 3100 using generative AI based on the prompt 3100 and descriptions of the “fileName” and “printConfig” parameters described as examples in the information 5015.

As a result, the AI assistant 3000 determines that the value “Sample1.pdf” is appropriate for the “fileName” parameter and the value “print 5 copies using economy printing” is appropriate for the “printConfig” parameter. It should be noted that in that case, specifically, the descriptions “the file name of the file content to be printed” and “the specific print setting, such as the number of copies, paper type, or whether duplex printing is enabled/disabled (or an abstract print setting, such as economy setting)” are used in the determination.

Further, in a case where an abstract file designation “Print 5 copies of a material for tomorrow's meeting using economy printing” is used to specify a printing target as illustrated in FIG. 4C, the AI assistant 3000 may refer to a schedule management function of the application 2000 and acquire the corresponding file. Specifically, for example, the AI assistant 3000 obtains a schedule of the user for the next day and performs a search to identify a file or folder including a character string corresponding to the scheduled conference, thereby acquiring the corresponding file. It should be noted that in a case where a file is attached to the schedule, the AI assistant 3000 may acquire the file.

In another method, the AI assistant 3000 obtains the next date (character string) based on the current date and performs a search to identify a file or folder including the character string, thereby acquiring the corresponding file.

It should be noted that, like the plug-in or parameter determination, the application 2000 may refer to the prompt 3100 and determine whether to perform the process of referring to the schedule management function of the application 2000 using generative AI or the like.

In step S106, the AI assistant 3000 transmits a request to generate the card 3200 to the plug-in server 6000. Upon receiving the request, the plug-in server 6000 causes the card creation process control unit 6010 controlled by the CPU 641 to start a process of generating the card 3200.

In step S107, the card creation process control unit 6010 controlled by the CPU 641 instructs the generative AI model 6020 to generate content. For example, the print plug-in server inputs the “printConfig” parameter designated in step S105, within the information received from the AI assistant 3000, to a generative AI model (the generative AI model 6020) and issues an instruction to generate a print setting in JSON format.

In step S108, the card creation process control unit 6010 receives content returned from the generative AI model 6020 and generates the card 3200 based on the received information. It should be noted that details of the card generation process will be described below with reference to FIG. 6B.

In step S109, the card creation process control unit 6010 controlled by the CPU 641 transmits (returns) the card 3200 generated in step S108 to the AI assistant 3000 of the computer 1000.

In step S110, upon receiving the card 3200 generated by the plug-in server 6000, the AI assistant 3000 transmits a request to generate a response to the AI assistant server 4000 using the prompt 3100 and the card 3200 as input. Upon receiving the request, a CPU 441 of the AI assistant server 4000 controls an LLM unit (not illustrated) and generates a response corresponding to the received request. It should be noted that the response will be returned by the AI assistant 3000 as a response to the prompt input by the user in step S101.

In step S111, the CPU 441 transmits (returns) the response generated using the LLM unit to the computer 1000.

In step S112, the AI assistant 3000 controlled by the CPU 141 displays the response from the AI assistant 3000 on the display unit 110 of the computer 1000. As a result, the card 3200 is displayed as illustrated in FIGS. 4A, 4B, 4C, or 4D, and the user may perform an operation on the plug-in server 6000 via the operation button 3250.

It should be noted that the processes of steps S110 and S111 may be omitted. For example, simultaneous display of summaries of the card 3200 returned by the plug-in server 6000 in response to the prompt 3100 input by the user and the card 3200 generated by the LLM unit may cause duplication of content. On the other hand, the user may wish to simultaneously display many elements on the card 3200 returned by the plug-in server 6000. In that case, it is possible to improve the user experience (UX) by generating a summary of the card 3200 generated by the LLM unit and displaying the summary without omitting the processes.

While an example of a basic sequence for invoking the plug-in 5000 has been described, the order of the sequence for invoking the plug-in 5000 is not limited to the example, and another process may be included in the sequence. Furthermore, in a case where a configuration capable of achieving the effect of the present disclosure is employed, some of the processes may be omitted.

### Card Creation Process of a Plug-In Execution Control Unit

Next, an example of a card creation process will be described with reference to FIG. 6B, describing the print plug-in described above in the section of the UI for posting a card as an example. It should be noted that the process illustrated in the flowchart is performed by the CPU 641 of the plug-in server 6000 by controlling the card creation process control unit 6010 and the generative AI model 6020.

Further, the process is a detail of the card generation process described above before or after step S108. The process is started when the AI assistant 3000 transmits a request to generate the card 3200 to the plug-in server 6000 (in step S106). It should be noted that at that time, the card creation process control unit 6010 starts the process of generating the card 3200.

It should be noted that, as described above, the print plug-in inputs at least two parameters, the file name 3110 and the print setting 3120, to the print plug-in server. Further, each apparatus communicates via its network communication unit.

In step S201, the card creation process control unit 6010 controlled by the CPU 641 performs an authentication process on the cloud storage used by the user to acquire file content of the file that the user wishes to print. It should be noted that authentication information about the user is input, for example, when the plug-in 5000 is added to the application 2000 by the user or when the plug-in 5000 is executed for the first time, and the authentication process is performed using the information.

In step S202, the card creation process control unit 6010 controlled by the CPU 641 instructs the cloud storage to search for a printing target. At that time, for example, the CPU 641 may issue the search instruction by transmitting a signal, such as a command, to a cloud service managing the cloud storage or the like. Upon receiving the instruction, the cloud storage performs a search based on the received instruction. Further, upon completion of the search, the search result is transmitted (returned) to the plug-in server 6000.

In step S203, the CPU 641 determines whether a printing target exists in the cloud storage. Specifically, for example, in a case where the search performed by the cloud storage is successful and a printing target is successfully identified, the CPU 641 receives information indicating the success. On the other hand, in a case where the search performed by the cloud storage fails and a printing target fails to be identified, the CPU 641 receives a signal indicating the failure. Thus, the CPU 641 determines whether a printing target exists based on the received information. It should be noted that the CPU 641 may be configured to determine that a printing target does not exist in a case where no response is received from the cloud storage although a predetermined time has passed.

In a case where the CPU 641 determines that a printing target exits based on the received signal (YES in step S203), the processing proceeds to step S204. In a case where the CPU 641 determines that a printing target does not exist (NO in step S203), the processing proceeds to step S212.

In step S204, the CPU 641 receives a printing target file following the signal received in step S203.

As a result, the CPU 641 acquires file content. It should be noted that a configuration may be employed in which in the case where it is determined that a printing target exists in the cloud storage, the CPU 641 receives a printing target file instead of the signal indicating the existence. In that case, in step S203, the CPU 641 determines that a printing target file exists upon receiving the file.

In step S212, the card creation process control unit 6010 controlled by the CPU 641 creates an error card (the card 3200), for example, as illustrated in FIG. 5F. It should be noted that a design of the error card at that time is not limited to the design illustrated in FIG. 5F, and a design and text appropriate for the content of the error are displayed.

In step S205, the card creation process control unit 6010 controlled by the CPU 641 performs an instruction statement creation process to generate the print setting 3120. As a result, an instruction statement is created.

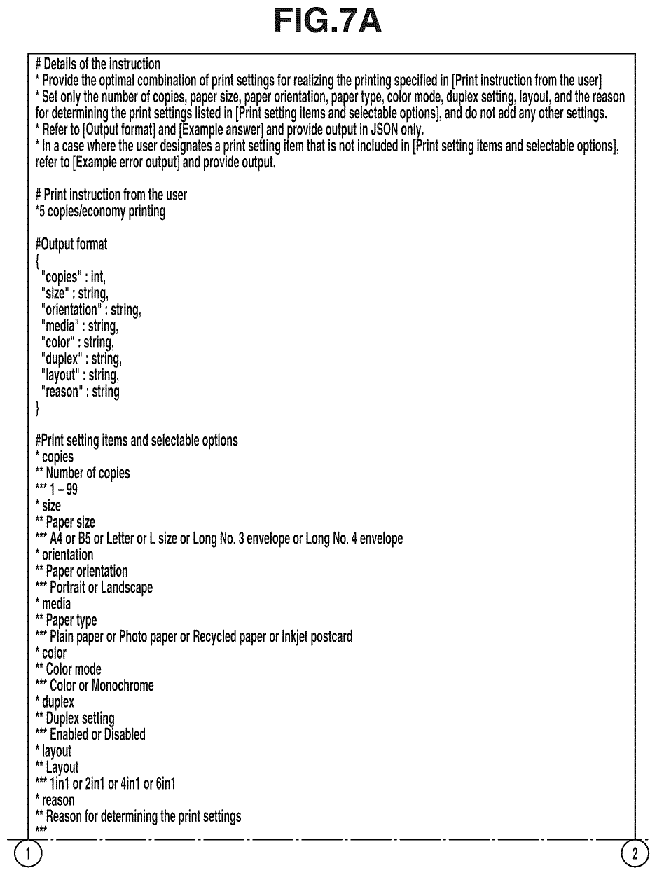

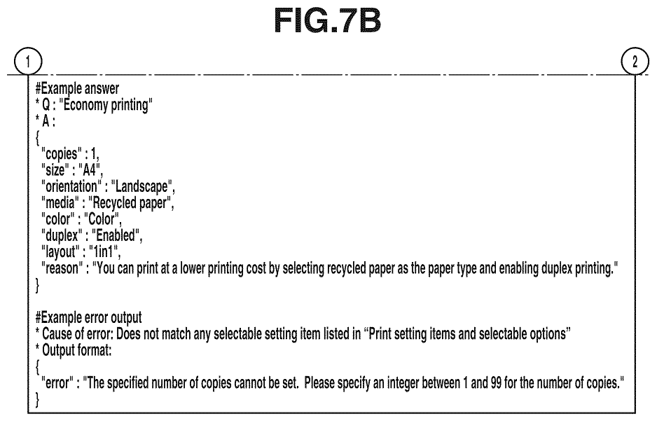

It should be noted that the content of the created instruction statement is not particularly limited and may be a character string in natural language including instruction content, a print instruction from the user, an output format, settable options for print settings, an example of a response, and an example of error output, as in an example illustrated in FIGS. 7A and 7B. The created instruction statement includes a character string in natural language (5 copies/economy printing) input by the user and further includes information indicating settable options for print settings (such as the number of copies, 1 to 99, paper size, A4, B5, and Letter). Further, a prompt including an instruction to configure a print setting based on the information indicating the options for print settings is also included. Further, a prompt designating a format of an output item output by the generative AI is also included. Further, an error message that is output in a case where it is determined that a print setting based on the information indicating the options for print settings cannot be set (a case where a setting specified in the prompt by the user falls outside the range of the option for the print setting) is also included.

In step S206, the card creation process control unit 6010 controlled by the CPU 641 transmits the instruction statement created in step S205 to the generative AI model 6020 and inputs the instruction statement. Upon inputting the instruction statement, the generative AI model 6020 controlled by the CPU 641 generates a print setting based on the instruction statement. Upon completion of print setting generation, the generative AI model 6020 returns the generated print setting to the card creation process control unit 6010.

In step S207, the card creation process control unit 6010 controlled by the CPU 641 receives the print setting 3120 generated by the generative AI model 6020

In step S208, the card creation process control unit 6010 controlled by the CPU 641 determines whether an error has occurred in the print setting. The CPU 641 checks the generated print setting 3120, and in a case where the CPU 641 determines that an error has occurred (YES in step S208), the processing proceeds to step S212. In step S212, the card creation process control unit 6010 controlled by the CPU 641 creates an error card.

For example, the determination process in step S208 is performed by determining whether a JSON file containing only a key value “error” is output, as described in the example error output in FIGS. 7A and 7B. In a case where the CPU 641 determines that no error has occurred in the generated print setting 3120 (NO in step S208), the processing proceeds to step S209.

In step S209, the card creation process control unit 6010 controlled by the CPU 641 generates a preview image based on the file content acquired in step S204 and the print setting 3120 generated in step S207. Specifically, for example, the generated preview image is an image in a state where the generated print setting is applied to the acquired file content.

In the preview image creation process, for example, a preview image may be created using a rule-based method or using a generative AI model.

In step S210, the card creation process control unit 6010 controlled by the CPU 641 creates a preview card using the card template 6030.

It should be noted that in steps S210 and S212, the card creation process control unit 6010 may perform pre-processing to adjust the appearance of the card 3200. For example, the print setting may be displayed as a list, as in the print setting display 3230 illustrated in FIG. 4A, rather than as text. To perform the foregoing display, the CPU 641 may create a character string including escaped text from JSON data.

Furthermore, the CPU 641 may change the size of an image or text displayed on the generated card based on the terminal executing the application 2000 in which the AI assistant 3000 is installed, i.e., the size of the display unit 110.

It should be noted that the CPU 641 may perform the process by adjusting a parameter or selectively using the card template 6030.

In step S211, the card creation process control unit 6010 controlled by the CPU 641 transmits the card 3200 created in step S210 to the computer 1000 and returns the card 3200 to the AI assistant 3000 of the application 2000.

Plug-In Invoking Sequence Executed When a Card Is Updated or a New Card Is Created

Next, a plug-in invoking sequence executed when a card is updated or a new card is created will be described with reference to FIG. 6C. In the sequence executed when a card is updated or a new card is created, unlike the sequence executed when a card is created, the plug-in server 6000 is invoked without using the AI assistant 3000. Thus, first, in step S301, the user inputs the prompt 3100 into the card 3200 on the application 2000. Then, in step S302, the card processing unit 2200 transmits update information about the card 3200 to the plug-in server 6000. At that time, the card 3200 may add information other than information about the input prompt 3100. For example, in the case of the print plug-in, information such as information about the current print setting 3120 or file content or an operation log of an operation previously performed via the AI assistant 3000 or the card 3200 may be transmitted. Thus, the card 3200 can include these pieces of information as parameters hidden on the card 3200. Alternatively, these pieces of information may be managed on the plug-in server 6000 side.

At the same time, the card 3200 may include information for identifying a destination to which the card 3200 is returned, such as an ID of the card 3200 (e.g., a card number 3290 described below in a second embodiment) or a chat ID in the AI assistant 3000. Next, in step S303, the card creation process control unit 6010 determines a parameter for executing the plug-in 5000, as the card 3200 itself does not include a function of extracting a parameter from the prompt 3100. In this process, as in step S105, a method for determining a parameter is not particularly limited.

In an example method, the description of each parameter held by the plug-in server 6000 is referenced based on the prompt input by the user, the information transmitted from the card processing unit 2200, and the information managed by the plug-in server 6000. Then, parameter extraction or generation is performed using AI. This parameter includes information for determining whether to update the card 3200 or to create a new card. As described above, in a case where the printing target file is changed (FIGS. 6C and 6D) or a case where the create new card setting button 3257 is enabled (FIGS. 6E and 6F), information for determining that a new card is created is included. Further, the same applies to cases such as a case where the card update button 3255 is executed on a card for which printing has been executed (FIGS. 6H and 6I). It is also possible to employ a configuration in which information for determining that a new card is created instead of updating the card 3200 is included based on another condition.

Processes performed in steps S304, S305, and S308 are similar to the processes performed in steps S107, S108, and S112, respectively, so that descriptions thereof are omitted. Further, in step S306, the card creation process control unit 6010 returns card information including the above-described information for determining whether to update the card 3200 or to create a new card. The card processing unit 2200 of the application 2000 updates the card 3200 (step S307) or posts a new card (step S308) based on the information for determination.

A sequence of processes performed among components of the application 2000, the AI assistant server 4000, and the plug-in server 6000 according to the present embodiment has been described with reference to FIGS. 6A to 6C. It should be noted that the sequence described above is merely an example and is not intended to be limiting.

By performing the above-described processes, the new card 3400 is generated and posted to the chat screen in a case where the natural language input into the prompt input field 3254 of the card 3200 is an instruction to print a file different from the file corresponding to the card 3200. Further, the original card 3200 is not deleted, and the user can refer to and perform an operation on the card 3200. This makes it possible to issue an instruction to print the new file while it is still easy to issue an instruction to print the original file. Further, applying the print setting for the original file to the new file obviates the need to configure a print setting for the new file.

### Card Template

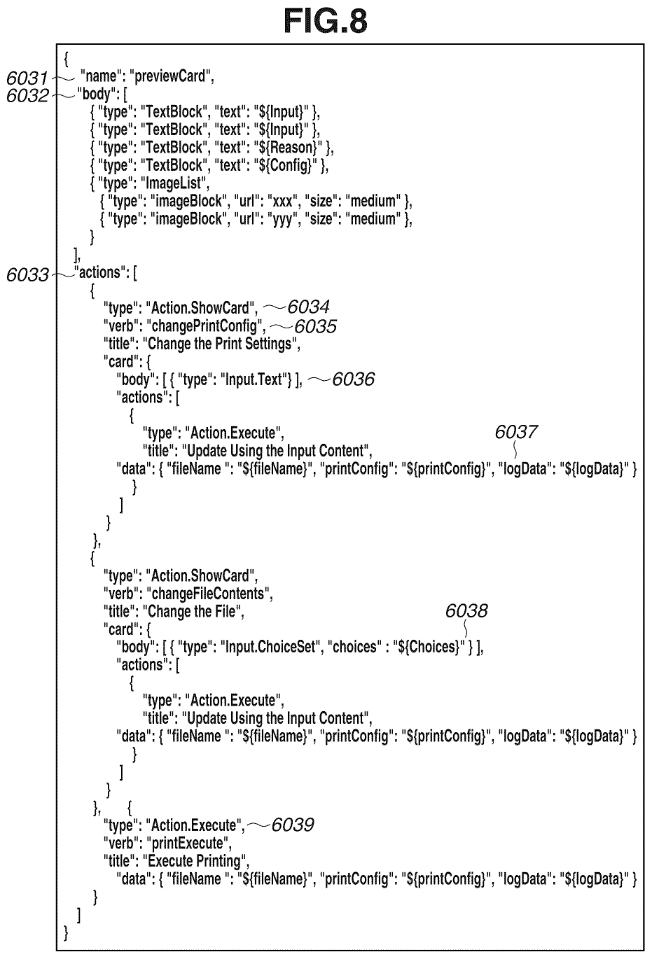

An example of the card template 6030 will be described with reference to FIG. 8, using the preview card of the print plug-in as an example. The card template 6030 illustrated in FIG. 8 is file content in JSON format and includes information 6031 to information 6038. The information 6031 describes a setting indicating a name of the card. The data structure 6032 is a data structure enclosed under the “body” key. In the example, settings for displaying elements, such as text, an image, or an input field, on the card UI are described, such as the input content display 3210, the generation rationale display 3220, the print setting display 3230, the preview image display 3240, the highlighted display 3260. In the example illustrated in FIG. 8, a description enclosed in ${ }, such as “${Input}”, is present, and the card creation process control unit 6010 of the plug-in server 6000 replaces a parameter, thereby creating a card appropriate for processing details. A data structure 6033 is a data structure enclosed under the “actions” key, is provided as a button on the card UI, and describes a setting related to the operation button 3250. A setting 6034 describes a setting for displaying the prompt input field 3254 and the card update button 3255, which are elements hidden in an initial state, by pressing the print setting change button 3251 as illustrated in FIG. 5A. It should be noted that the setting 6034 describes a setting for displaying the hidden elements by describing the data structure enclosed under the “body” key and the data structure enclosed under the “actions” key are described using a nested structure in the setting 6034. This form of description conforms to the specification of the application 2000. A setting 6035 describes a setting used by the card creation process control unit 6010 to determine which button on the card is executed by the user. A setting 6036 describes a setting for displaying the prompt input field 3254 on the card UI. A parameter 6037 describes a parameter continued to be applied by the plug-in server 6000 in a case where the card update button 3255 is executed. In the example illustrated in FIG. 8, settings concerning parameters associated with file content, print settings, and operation logs are described. A setting 6038 describes a setting for displaying the file selection field 3256. A setting 6039 describes a setting for displaying the print execution button 3253.

The above-described content is merely an example in the print plug-in, and the content of the card template 6030 is not limited to the example and conforms to the specifications of the application 2000 and the plug-in 5000.

### Second Embodiment

A second embodiment of the present disclosure will be described. In the second embodiment, a configuration will be described in which the card 3200 is updated in a case where a second prompt (3600) is input by the user instead of inputting an instruction into the prompt input field 3254. Descriptions of configurations and processes similar to those in the first embodiment are omitted.

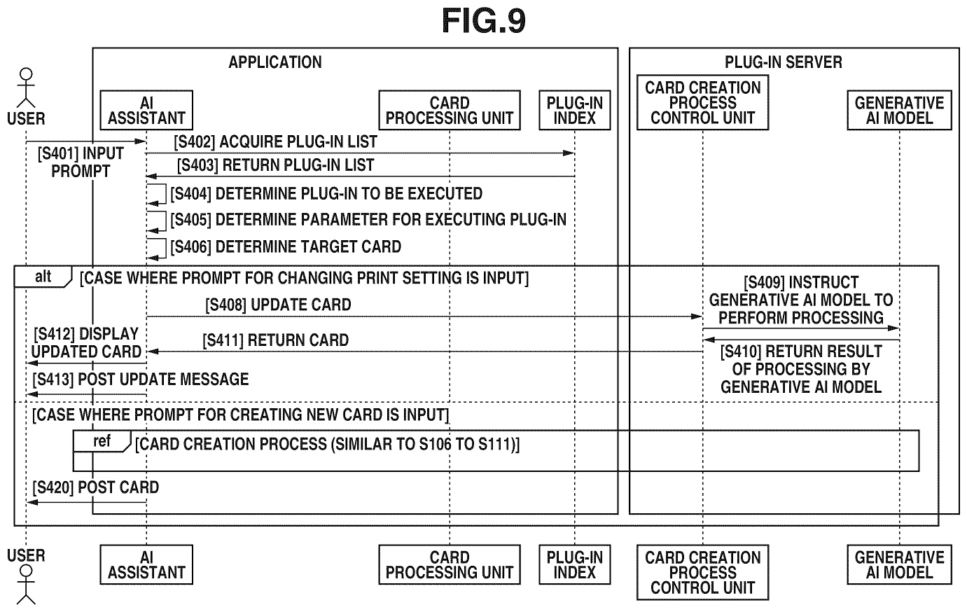

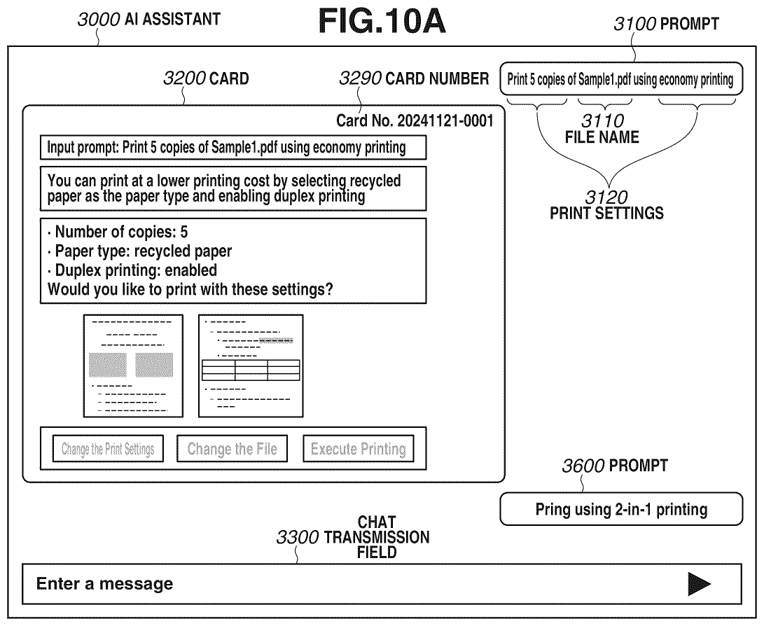

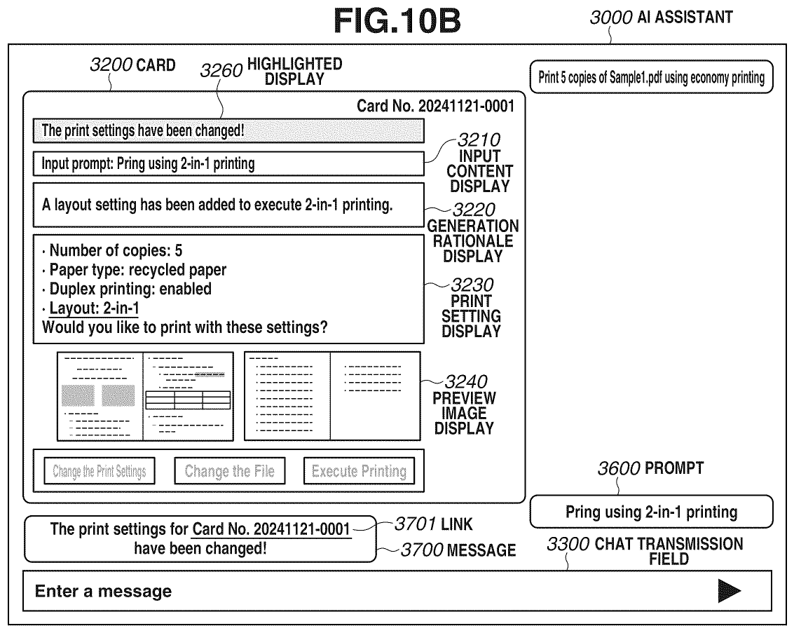

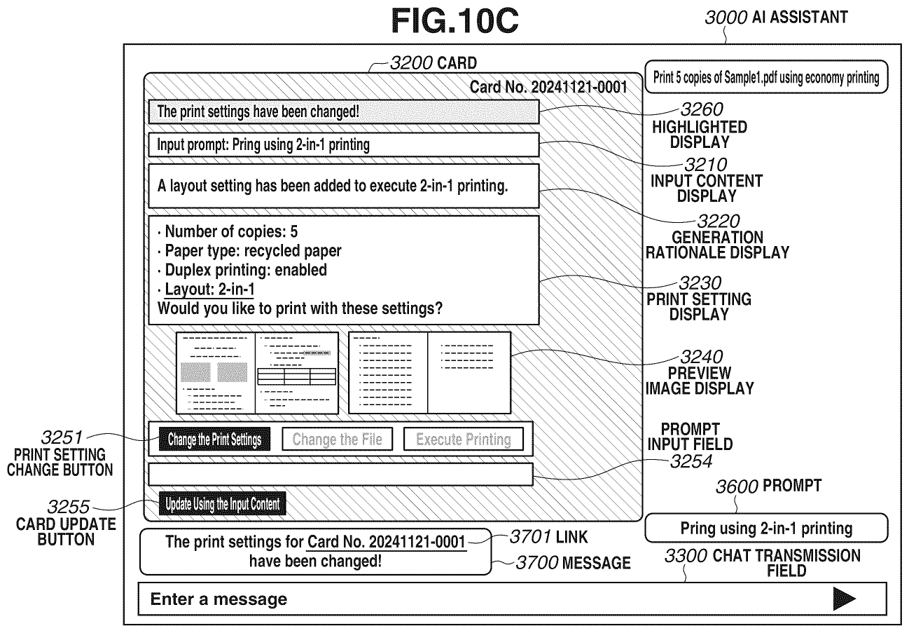

A sequence according to the second embodiment in which the plug-in 5000 is invoked in a case where the AI assistant 3000 updates or creates a card will be described with reference to FIGS. 9, 10A, 10B, and 10C. In the present embodiment, the card 3200 illustrated in FIG. 4A is considered as being generated and posted.

In step S401, the user inputs a prompt 3600 into the chat transmission field 3300 and transmits the prompt 3600 to the AI assistant 3000 of the application 2000. Then, first, in step S402, the AI assistant 3000 requests a list of plug-ins 5000 registered in the application 2000 from the plug-in index 2100. Next, in step S403, the plug-in index 2100 returns the list of plug-ins 5000. In step S404, the plug-in 5000 determines a plug-in 5000 to be executed in response to the user instruction input as the prompt 3600. A method for determining a plug-in 5000 is not particularly limited. In an example method, a description of each plug-in 5000 (natural language description regarding the plug-in 5000) is referenced, and a keyword search or a concept search using AI is performed based on the prompt 3600 input by the user. Further, in a case where there is a plurality of appropriate plug-ins 5000, the processes may be performed for each plug-in 5000. In a case where there is no appropriate plug-in 5000, the processes for the plug-in 5000 may not be performed. Furthermore, a plurality of commands may be included in a single plug-in 5000, and the plug-in 5000 may be determined on a per-command basis by referring to a description set for each command. Once the plug-in 5000 to be executed and a command of the plug-in 5000 are determined, the AI assistant 3000 determines a parameter for executing the plug-in 5000 in step S405. It should be noted that a method for determining a parameter in step S405 is not particularly limited. In an example method, the description of each parameter is referenced based on the prompt 3600 input by the user, the operation log managed by the AI assistant 3000, and other information inside and outside the application 2000 that can be acquired from the AI assistant 3000. Then, parameter extraction or generation is performed using AI.

In step S406, the AI assistant 3000 determines a target card for which a print setting is to be changed. Normally, the most recently posted card is determined as a target. Depending on the input natural language, a card posted earlier may be determined as a target, or the card ID for identifying a card, such as the card number 3290, may be used to determine a target card.

In a case where a target card is successfully determined, the AI assistant 3000 performs the card updating process (steps S408 to S413). In a case where the AI assistant 3000 determines that a target card does not exist, the AI assistant 3000 creates a new card (this process is similar to steps S106 to S112 described above, so that descriptions thereof are omitted).

In steps S408 to S412, processes similar to the processes performed in steps S302 to S307 illustrated in FIG. 6C are performed. The difference is that the plug-in server 6000 is invoked from the AI assistant 3000 whereas the plug-in server 6000 is invoked from the card 3200 in FIG. 6C. Then, in step S413, the AI assistant 3000 posts a message notifying that the card 3200 has been updated. A message 3700 is an example of the message and includes a link 3701 to the updated card 3200.

In a case where a link 3701 is selected, the entire card may be highlighted and displayed, as illustrated by a slashed portion of the card 3200 in FIG. 10C, thereby improving visibility for the user. Further, a configuration may be employed in which the prompt input field 3254 and the card update button 3255 are displayed even in a case where the print setting change button 3251 is not executed, thereby prompting the user to input a prompt into the prompt input field 3254 in a case where the user wishes to further change a print setting.

In the first embodiment, an example is described in which the user inputs an instruction to change a print setting into the prompt input field 3254 displayed upon executing the print setting change button 3251 displayed in the card 3200. In such cases, the user may not understand how to execute the print setting change button 3251 or how to use the prompt input field 3254 and may issue an instruction to change a print setting by inputting a prompt again. In the second embodiment, even in such cases, it is possible to update the card (to change the print setting) as intended by the user. Further, posting the message 3700 including the link 3701 after the card is updated makes it easier for the user to recognize the updated card.

The present disclosures makes it possible to facilitate the designation of a printing target file specified by the user using natural language.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-030141, filed Feb. 27, 2025, which is hereby incorporated by reference herein in its entirety.

What is claimed is:

1. A non-transitory computer-readable storage medium storing a program for causing a computer to execute a method, the method comprising:
displaying a first object configured to configure a print setting for a first file, the first object including an input field,
wherein in a case where a natural language indicating an instruction to print a second file different from the first file is input into the input field, a second object configured to configure a print setting for the second file is displayed in a state where the first object is displayed.

2. The non-transitory computer-readable storage medium according to claim 1, wherein the first object and the second object are displayed on a chat screen.

3. The non-transitory computer-readable storage medium according to claim 1,
wherein the first object includes the print setting and a print preview of the first file, and
wherein the second object includes the print setting and a print preview of the second file.

4. The non-transitory computer-readable storage medium according to claim 1, wherein in a case where a natural language indicating an instruction to print the first file is input into another input field different from the input field, the first object is displayed.

5. The non-transitory computer-readable storage medium according to claim 4, wherein in the case where the natural language indicating the instruction to print the second file different from the first file is input into the input field, the second object is displayed in a state where the first object and the other input field are displayed.

6. The non-transitory computer-readable storage medium according to claim 1, wherein in a case where a natural language input into the input field is a natural language indicating an instruction to change the print setting, the second object is hidden, and the first object for which the print setting is updated is displayed.

7. An information processing method comprising:
displaying a first object configured to configure a print setting for a first file, the first object including an input field,
wherein in a case where a natural language indicating an instruction to print a second file different from the first file is input into the input field, a second object configured to configure a print setting for the second file is displayed in a state where the first object is displayed.

8. An information processing apparatus comprising:
one or more processors; and
at least one memory storing executable instructions, which when executed by the one or more processors, cause the information processing apparatus to operate as:
a display unit configured to display a first object configured to configure a print setting for a first file, the first object including an input field,
wherein in a case where a natural language indicating an instruction to print a second file different from the first file is input into the input field, the display unit displays a second object configured to configure a print setting for the second file in a state where the first object is displayed.

9. The information processing apparatus according to claim 8, wherein the display unit displays the first object and the second object on a chat screen.

10. The information processing apparatus according to claim 8,
wherein the first object includes the print setting and a print preview of the first file, and
wherein the second object includes the print setting and a print preview of the second file.

11. The information processing apparatus according to claim 8, wherein in a case where a natural language indicating an instruction to print the first file is input into another input field different from the input field, the display unit displays the first object.

12. The information processing apparatus according to claim 11, wherein in the case where the natural language indicating the instruction to print the second file different from the first file is input into the input field, the display unit displays the second object in a state where the first object and the other input field are displayed.

13. The information processing apparatus according to claim 8, wherein in a case where a natural language input into the input field is a natural language indicating an instruction to change the print setting, the display unit hides the second object and displays the first object for which the print setting is updated.
